(19) United States
(12) Patent Application Publication
(10) Pub. No.: US 2026/0351791 A1
(43) Pub. Date: Nov. 5, 2026

(54) METHOD FOR PREPARING POROUS SUBSTRATE OF SEPARATOR FOR RECHARGEABLE BATTERY, SEPARATOR FOR RECHARGEABLE LITHIUM BATTERY, AND RECHARGEABLE BATTERY

(71) Applicant: SAMSUNG SDI CO., LTD., Yongin-si (KR)

(72) Inventors: Seung Woo LEE, Suwon-si (KR); Min Hee KIM, Suwon-si (KR); Sun A LEE, Suwon-si (KR); Han Woong CHO, Suwon-si (KR); Hui Jeong CHO, Suwon-si (KR)

(73) Assignee: SAMSUNG SDI CO., LTD., Yongin-si (KR)

(21) Appl. No.: 19/660,991

(22) Filed: Apr. 28, 2026

(30) Foreign Application Priority Data
Apr. 30, 2025 (KR) 10-2025-0057222
Apr. 30, 2025 (KR) 10-2025-0057225
Jun. 11, 2025 (KR) 10-2025-0076272

(51) Int. Cl. H01M 50/403; H01M 10/0525; H01M 50/417; H01M 50/44; H01M 50/494

(52) U.S. Cl. CPC H01M 50/403; H01M 50/417; H01M 50/44; H01M 50/494; H01M 10/0525

(57) ABSTRACT

The present disclosure relates to a method of manufacturing a porous substrate of a separator for a rechargeable battery, a separator for a rechargeable battery, and a rechargeable battery. The method of manufacturing a porous substrate of a separator for a rechargeable battery includes manufacturing a first film including a mixture of a first resin and a filler, the filler includes a linear filler, and the manufacturing of the first film includes separately inputting the first resin and a mixture of the linear filler and oil into an extruder, and performing extrusion.

### CROSS-REFERENCE TO RELATED APPLICATION

The present application claims priority and the benefit of Korean Patent Application No. 10-2025-0057222, filed on Apr. 30, 2025 in the Korean Intellectual Property Office, Korean Patent Application No. 10-2025-0057225, filed on Apr. 30, 2025 in the Korean Intellectual Property Office, and Korean Patent Application No. 10-2025-0076272, filed on Jun. 11, 2025 in the Korean Intellectual Property Office, the entire disclosures of each of the above-identified applications are incorporated herein by reference.

### BACKGROUND

### 1. Field of the Disclosure

The present disclosure relates to a method of manufacturing a porous substrate of a separator for a rechargeable battery, a separator for a rechargeable battery including the porous substrate manufactured thereby, and a rechargeable battery including the separator. The present disclosure relates to a separator for a rechargeable battery, and a rechargeable battery including the separator.

### 2. Discussion of Related Art

With increasing presence of electronic devices such as, e.g., mobile phones, notebook computers, electric vehicles and the like that use batteries, the demand for secondary batteries having high energy density and high capacity is increasing. Therefore, improving the performance of rechargeable lithium batteries may be advantageous.

A rechargeable lithium battery typically includes a positive electrode and a negative electrode that both contain an active material capable of the intercalation and deintercalation of lithium ions, and produces electric energy by oxidation and reduction reactions when the lithium ions are intercalated into and deintercalated from the positive electrode and the negative electrode.

In order to maximize capacity, attempts are being made to increase the content of positive and/or negative electrode active materials, while thinning the separator. Thin separators may have weak dendrite resistance due to having low strength. A separator that has weak dendrite resistance can cause a short circuit in the battery, which can reduce the reliability and safety of the battery.

### SUMMARY

One example embodiment includes a porous substrate of a separator for a rechargeable battery including a linear filler and having improved puncture strength, improved air permeability, improved thermal shrinkage, improved tensile strength, and improved physical property distribution, and a method of manufacturing the porous substrate.

Another example embodiment includes a porous substrate of a separator for a rechargeable battery including a filler made of or including the same material as a matrix and having improved puncture strength, improved air permeability, improved thermal shrinkage, improved tensile strength, and improved physical property distribution, and a method of manufacturing the porous substrate.

One example embodiment includes a method of manufacturing a porous substrate of a separator for a rechargeable battery.

The manufacturing method includes manufacturing a first film including a mixture of a first resin and a filler, wherein the filler includes a linear filler, the manufacturing of the first film includes separately inputting the first resin and a mixture of the linear filler and oil separately into an extruder and performing extrusion, and the linear filler includes a filler including the first resin.

Another example embodiment includes a separator for a rechargeable battery.

The separator for a rechargeable battery includes a porous substrate manufactured by the manufacturing method.

Still another example embodiment includes a rechargeable battery.

The rechargeable battery includes a positive electrode, a negative electrode, and the above-described separator for a rechargeable battery located between the positive electrode and the negative electrode.

According to one example embodiment, the reliability and safety of the battery can be increased by providing porous substrates with improved puncture strength, air permeability, thermal shrinkage, and tensile strength.

One example embodiment includes a separator for a rechargeable battery having desired or improved adhesion between a porous substrate and an aqueous coating layer.

Another example embodiment includes a separator for a rechargeable battery having improved electrolyte wettability of a porous substrate.

Another example embodiment includes a separator for a rechargeable battery having a porous substrate with improved puncture strength.

One example embodiment includes a separator for a rechargeable battery.

The separator for a rechargeable battery includes a porous substrate, a coating layer formed on at least one surface of the porous substrate, wherein the porous substrate includes an intermediate layer, a first surface layer formed on a first surface of the intermediate layer, and a second surface layer formed on a second surface of the intermediate layer. The first surface layer and the second surface layer each include a copolymer of a monomer mixture including a range of about 1 wt % to about 40 wt % of a monomer having a hydrophilic group. The intermediate layer includes a mixture of a polyolefin-based resin and a copolymer of a monomer mixture including a range of about 1 wt % to about 40 wt % of a monomer having a hydrophilic group.

Another example embodiment includes a rechargeable battery.

The rechargeable battery includes a positive electrode, a negative electrode, and the separator for a rechargeable battery located between the positive electrode and the negative electrode.

According to one example embodiment, a rechargeable battery is provided in which the adhesion between the porous substrate and the aqueous coating layer is desired or improved, and thermal shrinkage in each of a machine direction and a transverse direction of the porous substrate is remarkably low, thereby improving the reliability and safety of the battery.

According to another example embodiment, electrolyte wettability is improved, thereby improving the output of the battery and enhancing the capacity of the battery.

According to another example embodiment, puncture strength is improved, thereby enhancing the strength and reliability of the separator.

One example embodiment includes a separator for a rechargeable battery having desired or improved adhesion between a porous substrate and an aqueous coating layer.

Another example embodiment includes a separator for a rechargeable battery having improved electrolyte impregnability or electrolyte wettability of a porous substrate.

Still another example embodiment includes a separator for a rechargeable battery having a porous substrate with improved puncture strength.

One example embodiment includes a separator for a rechargeable battery.

The separator for a rechargeable battery includes a porous substrate and a coating layer formed on at least one surface of the porous substrate, wherein the porous substrate includes an intermediate layer, a first surface layer formed on a first surface of the intermediate layer, and a second surface layer formed on a second surface of the intermediate layer, the first surface layer and the second surface layer each include nylon, the intermediate layer includes a mixture of a polyolefin-based resin and nylon.

Another example embodiment includes a rechargeable battery.

The rechargeable battery includes a positive electrode, a negative electrode, and the separator for a rechargeable battery located between the positive electrode and the negative electrode.

According to one example embodiment, a rechargeable battery is provided in which the adhesion between the porous substrate and the aqueous coating layer is desired or improved, and thermal shrinkage in each of a machine direction and a transverse direction of the porous substrate is remarkably low, thereby improving the reliability and safety of the battery.

According to another example embodiment, electrolyte wettability is improved, thereby improving the output of the battery and enhancing the capacity of the battery.

According to another example embodiment, puncture strength is improved, thereby enhancing the strength and reliability of the separator.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view of a separator for a rechargeable battery according to one example embodiment;

FIG. 2 is a plan view of a porous substrate according to one example embodiment;

FIG. 3 is a cross-sectional view of a porous substrate of a separator for a rechargeable battery according to one example embodiment;

FIG. 4 is a cross-sectional view of a separator for a rechargeable battery according to one example embodiment;

FIG. 5 is a cross-sectional view of a porous substrate of a separator for a rechargeable battery according to one example embodiment; and

FIG. 6 is a cross-sectional view of a separator for a rechargeable battery according to one example embodiment.

FIG. 7 to FIG. 10 are each a cross-sectional view schematically illustrating a lithium secondary battery according to one example embodiment.

FIG. 11 is a flowchart illustrating a method of manufacturing a porous substrate of a separator for a rechargeable battery, according to an example embodiment.

### DETAILED DESCRIPTION

Hereinafter, example embodiments of the present disclosure are described in detail. However, the example embodiments are presented as examples, the present disclosure is not limited thereto, and the present disclosure is only defined by the scope of the appended claims.

Unless otherwise stated herein, when a part such as a layer, a membrane, an area, a plate, and the like, is described as being disposed “on” another part, it includes not only a case where the part is “directly on” another part, but also a case where there are other parts therebetween.

Unless otherwise stated herein, the singular may also include the plural. In addition, unless otherwise stated, the term “A or B” may mean “including A, including B, or including A and B.”

In the present specification, “a combination thereof” may mean a mixture, stack, composite, copolymer, alloy, blend, or reaction product of constituents.

Unless otherwise defined herein, ‘a particle size D50’ may refer to a size of a particle with a cumulative volume of 50% by volume in a particle size distribution. The particle size distribution may be measured by methods well known to those skilled in the art. For example, the particle size distribution may be measured using a particle size analyzer, a transmission electron microscope (TEM) photograph, or a scanning electron microscope (SEM) photograph. As another method, the particle size distribution may be obtained by measuring the particle size using a measuring device using dynamic light scattering, performing data analysis to count the number of particles for each particle size range, and then calculating the particle size D50 therefrom. Alternatively, the particle size distribution may be measured using a laser diffraction method. When measuring the particle size distribution by the laser diffraction method, for example, the particle size D50 based on 50% of a particle size distribution in the measuring device may be calculated by dispersing particles to be measured in a dispersion medium, then introducing the dispersion medium into a commercially available laser diffraction particle size measuring device (e.g., Microtrac's MT 3000), and radiating ultrasonic waves of about 28 kHz with an output of 60 W.

If (when) the particle is spherical, the size may mean a diameter.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, a separator for a rechargeable battery may be used in a rechargeable lithium battery. However, the present disclosure is not limited thereto, and the separator may be applicable to metal rechargeable batteries such as, e.g., sodium rechargeable batteries, in addition to the rechargeable lithium batteries.

### Disclosure According to First Example Embodiment

According to one example embodiment, a method of manufacturing a porous substrate of a separator for a rechargeable battery is provided.

In one example embodiment, the porous substrate includes a matrix, and a filler impregnated into the matrix, wherein the matrix includes pores, and the filler includes a linear filler. In one example embodiment, the matrix may be porous.

The manufacturing method can provide a porous substrate for a rechargeable battery separator including a linear filler and having improved puncture strength, air permeability, thermal shrinkage and tensile strength. For example, the manufacturing method can provide a porous substrate of a separator for a rechargeable battery including a filler made of or including the same material as a matrix and having improved puncture strength, air permeability, thermal shrinkage, and tensile strength. For example, the manufacturing method can provide a separator for a rechargeable battery having improved puncture strength, air permeability, thermal shrinkage, and tensile strength by including the porous substrate.

According to one example embodiment, the manufacturing method includes manufacturing a first film including a mixture of a first resin and a filler, wherein the filler includes a linear filler, and the manufacturing of the first film includes separately inputting the first resin and a mixture of the linear filler and oil into an extruder and performing extrusion.

The linear filler may mean a filler having a relatively large length relative to its diameter.

Therefore, the linear filler may be advantageous in improving the physical properties of the porous substrate, such as tensile strength, compared to spherical fillers, platy fillers, and amorphous fillers. However, the linear filler cannot avoid being exposed to high temperature, high pressure, and high shear stress during the process of manufacturing the porous substrate. Although not particularly limited, the high temperature, high pressure, and high shear stress may occur during the melt-kneading process of the first resin. This may be detrimental to the improvement of the physical properties of the porous substrate by the linear filler, as the melt-kneading process of the first resin may cause fracture, breakage, and melting of the linear filler. In particular, when the linear filler is a nanofiber having a diameter in the nanometer range, the fracture, breakage, and melting may be severe.

The manufacturing method can provide a porous substrate including the linear filler and having improved puncture strength, improved air permeability, improved thermal shrinkage and improved tensile strength.

The manufacturing method can improve the manufacturing reliability of the porous substrate by substantially maintaining the shape of the linear filler before mixing with the first resin forming the matrix and the shape of the linear filler in the porous substrate.

The manufacturing method can provide a porous substrate having a thin thickness.

In one example embodiment, the porous substrate may have a thickness of about 10 μm or less, for example, more than about 0 μm and about 10 μm or less, more than 0 μm and 9 μm or less, or 5 to 10 μm.

In one example embodiment, the porous substrate may have a puncture strength of about 600 gf or more, for example, in a range of about 600 gf to about 1200 gf, or 600 to 1000 gf. In the above range, the fracture of the separator may be reduced.

In one example embodiment, the porous substrate may have a thermal shrinkage rate of about 10% or less, for example, about 5% or less, in each of the machine direction (MD) and the transverse direction (TD) of the porous substrate. In the above range, shrinkage of the separator during charging and discharging of the battery can be reduced, thereby increasing the reliability of the battery.

Here, the machine direction may be a direction in which extrusion is performed during the manufacturing process of the porous substrate, and the transverse direction may be a direction substantially perpendicular to the machine direction.

In one example embodiment, the porous substrate may have an air permeability of about 200 sec/100 cc or less, for example, 150 sec/100 cc or less. In the above range, the resistance of lithium ions may not increase during charging and discharging of the battery.

In one example embodiment, the porous substrate may have a tensile strength of about 2500 kgf/cm² or more, for example, in a range of about 2500 kgf/cm² to about 4000 kgf/cm² in each of the MD and TD of the porous substrate. In the above range, the fracture of the separator may be reduced.

Hereinafter, the method of manufacturing a porous substrate according to an example embodiment is described in detail.

### Manufacture of First Film

The manufacturing method includes a step of manufacturing a first film including a mixture of a first resin and a filler.

The first film includes the mixture of the first resin and the filler. The first resin in the mixture may be included in an amount equal to or greater than the amount of the filler. This can increase the film formability of the first film.

In one example embodiment, the first resin may be included in the mixture in an amount in a range of about 50 wt % to about 80 wt % for example 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 wt %, and the filler may be included in an amount in a range of about 20 wt % to about 50 wt % for example 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 wt %. In the above range, the strength of the first film is not excessively high, so that the ductility of the first film is desired or improved, and stretching is possible. For example, in the above range, the thermal shrinkage rate of the porous substrate may not increase.

The mixture of the first resin and the filler in the first film may be included in an amount of about 50 wt % or more, for example, about 80 wt % or more. In the above range, the mixture can be advantageous for manufacturing the porous substrate.

The first film may further include, in addition to the mixture, a film-forming solvent and oil as described below. The film-forming solvent may contribute to the formation of pores by being removed through volatilization during the porous substrate manufacturing process. The oil may contribute to the dispersion of the filler. For example, the oil may contribute to the formation of pores by being removed through volatilization during the porous substrate manufacturing process.

The first resin may include a conventional resin that forms the porous substrate of the separator for a rechargeable battery. For example, the first resin may include any one polymer such as or including at least one of polyolefins such as polyethylene and polypropylene, polyesters such as polyethylene terephthalate and polybutylene terephthalate, polyacetal, polyamide, polyimide, polycarbonate, polyether ketone, polyarylether ketone, polyether imide, polyamide imide, polybenzimidazole, polyether sulfone, polyphenylene oxide, a cyclic olefin copolymer, polyphenylene sulfide, polyethylene naphthalate, glass fiber, Teflon, and polytetrafluoroethylene, or at least one copolymer of two or more thereof. For example, the first resin may be or include a polyolefin-based resin, for example, a polyethylene-based resin.

The first resin may have a weight average molecular weight of about 1.5 million g/mol or less. In the above range, the viscosity is not too high, so that the porous substrate is readily manufactured, the appearance of the porous substrate is as desired, and the deviation of the above physical properties of the porous substrate may not be high. For example, the first resin may have a weight average molecular weight of about 1.3 million g/mol or less, 1.2 million g/mol or less, or in a range of about 500,000 g/mol to about 1.3 million g/mol.

Here, the weight average molecular weight may be obtained as a polystyrene-converted value by gel permeation chromatography.

In one example embodiment, the first resin may be included in the matrix of the porous substrate in an amount of about 95 wt % or more, for example, a range of about 95 wt % to about 100 wt % or 100 wt %.

The filler includes a linear filler.

In one example embodiment, the linear filler may be included in the filler of the porous substrate in an amount of about 95 wt % or more, for example, a range of about 95 wt % to about 100 wt %, or 100 wt %.

The linear filler may include a filler having a relatively large length relative to its diameter. Therefore, the linear filler may be advantageous in improving the physical properties of the porous substrate, such as tensile strength.

The linear filler may be or include one or more of a needle-shaped, fibrous, or rod-shaped filler. For example, the linear filler may be or include a fibrous filler. The fibrous filler may have a desired or improved effect in improving the tensile strength of the porous substrate.

In one example embodiment, the fibrous filler may have an aspect ratio of about 10 or more, for example, 50 or more, 100 or more and about 1000 or less, 500 or less, or 300 or less. In the above range, the fibrous filler can be advantageous for improving the physical properties of the porous substrate. Here, ‘aspect ratio’ may mean the ratio of the length of the filler to the diameter of the filler.

The fibrous filler may be or include a nanofiber having a diameter in the nanometer range. Since the nanofiber has a small diameter, the increase in air permeability of the porous substrate may be reduced and the strength of the porous substrate may increase. For example, a diameter of the fibrous filler may be about 500 nm or less, for example, in a range of about 10 nm to about 300 nm. Here, the diameter of the fibrous filler may be obtained as an average value through a scanning electron microscope (SEM).

The linear filler is a linear filler formed of or including the first resin.

In one example embodiment, the first resin forming the linear filler may include any one polymer such as or including at least one of polyolefins such as polyethylene and polypropylene, polyesters such as polyethylene terephthalate and polybutylene terephthalate, polyacetal, polyamide, polyimide, polycarbonate, polyether ketone, polyarylether ketone, polyether imide, polyamide imide, polybenzimidazole, polyether sulfone, polyphenylene oxide, a cyclic olefin copolymer, polyphenylene sulfide, polyethylene naphthalate, glass fiber, Teflon, and polytetrafluoroethylene, or at least one copolymer of two or more thereof.

The first film may include a matrix including a first resin, and a linear filler formed of or including the first resin. When the components of the matrix and the filler are different from each other, the filler may be readily detached from the matrix during the process of manufacturing the porous substrate, which may result in problems such as poor appearance of the porous substrate and deterioration of physical properties of the porous substrate. On the other hand, the first film may not have the above-described problems.

In one example embodiment, the matrix and the linear filler may be formed of or include the same first resin. For example, the matrix may include a polyethylene-based resin, and the linear filler may be or include a filler formed of or including the polyethylene-based resin. The weight average molecular weight of the polyethylene-based resin of the matrix may be the same as, or different from, the weight average molecular weight of the polyethylene-based resin of the filler, and for example may be substantially the same.

The first resin forming the linear filler may have a weight average molecular weight of about 1.5 million g/mol or less. In the above range, the viscosity is not too high, so that the porous substrate is readily manufactured, the appearance of the porous substrate is as desired, and the deviation of the above physical properties of the porous substrate may not be high. For example, the first resin may have a weight average molecular weight of about 1.3 million g/mol or less, 1.2 million g/mol or less, or in a range of about 500,000 g/mol to about 1.3 million g/mol.

The first film may be manufactured by inputting the first resin and a mixture of the linear filler and oil into an extruder, and then performing extrusion. At this time, the first resin is input into the extruder separately from the mixture of the linear filler and the oil.

The first resin may be input into a hopper connected to the extruder and then melted within the extruder. The melting may involve high temperature, high pressure, and a high shear force. In the manufacturing method, the mixture of the linear filler and the oil is input into the extruder separately from the first resin. This can reduce the time that the linear filler is exposed to the high temperature, high pressure, and high shear force, thereby significantly reducing the degree of fracture, breakage, and melting of the linear filler. When the first resin and the linear filler are input separately, the dispersibility of the linear filler within the first resin may be reduced. The oil may improve the dispersibility of the linear filler within the first resin even when the first resin and the linear filler are input separately.

After the first resin is input into the extruder, a mixture of the linear filler and the oil may be input. Therefore, the time during which the mixture of the linear filler and the oil is exposed to the high temperature, high pressure, and high shear force can be reduced.

In the extruder, the first resin is input into a hopper, and while melting the first resin, the melt of the first resin is moved through a screw, and during the movement of the melt of the first resin, the mixture of the linear filler and the oil may be input. Therefore, the time during which the mixture of the linear filler and the oil is exposed to the high temperature, high pressure, and high shear force can be reduced.

The first resin may be input into the extruder, for example the hopper, once or multiple times.

The mixture of the linear filler and the oil may be input into the extruder once or multiple times. For example, the mixture of the linear filler and the oil is input multiple times in a divided manner so that the dispersibility of the linear filler can be further improved.

The linear filler may be included in the mixture of the linear filler and the oil in an amount in a range of about 10 parts by weight to about 50 parts by weight based on 100 parts by weight of the oil. In the above range, the oil may constitute a dispersing solvent for the linear filler, thereby improving the dispersibility of the linear filler. For example, the linear filler may be included in an amount in a range of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 parts by weight or about 10 parts by weight to about 30 parts by weight, or 10 parts by weight to 25 parts by weight, based on 100 parts by weight of the oil.

The linear filler may be the same as described above.

The oil is not particularly limited as a diluent that may be mixed with the polyolefin-based resin used in the present disclosure, and may be or include any organic compound that forms a single phase with the polyolefin-based resin at the extrusion temperature.

Non-limiting examples of the diluent may include aliphatic or cyclic hydrocarbons such as at least one of liquid paraffin (or paraffin oil) such as nonane, decane, decalin, and liquid paraffin (LP), paraffin wax, and the like; phthalic acid esters such as dibutyl phthalate (DBP) and dioctyl phthalate (DOP); fatty acids having a range of about 10 carbon atoms to about 20 carbon atoms such as palmitic acid, stearic acid, oleic acid, linoleic acid, and linolenic acid; and fatty acid alcohols having a range of about 10 carbon atoms to about 20 carbon atoms such as at least one of palmitic alcohol, stearic alcohol, and oleic alcohol. These aliphatic or cyclic hydrocarbons may be used alone or in combination of two or more. For example, paraffin oil that is harmless to the human body, has a high boiling point, and low volatile components is suitable, and for example, paraffin oil having a kinetic viscosity at 40 °C in a range of about 20 cSt to about 200 cSt is suitable.

The first film may be manufactured by inputting the first resin and the mixture of the linear filler and the oil into the extruder and performing extrusion through a die of the extruder in the extruder. For example, the first film may be manufactured by extruding a melt of the first resin and the film-forming solvent and the mixture of the linear filler and the oil through a die of the extruder.

Extrusion conditions in the die, such as extrusion temperature and extrusion pressure, may be adjusted according to the thickness of the first film and the like.

The film-forming solvent may be any of the common types known to those skilled in the art.

In one example embodiment, a thickness of the first film may be in a range of about 1500 μm to about 5000 μm, for example, 2000 μm to 3500 μm. In the above range, it is possible to readily manufacture a porous substrate having the above-described thickness without fracture due to stretching.

### Manufacture of Second Film

The first film may be converted into a second film by stretching. The first film may be converted into a second film by stretching in at least one axial direction.

The stretching may include single stretching or multi-stage stretching. In one example embodiment, the multi-stage stretching may include primary stretching and secondary stretching, and the primary stretching and secondary stretching may be performed sequentially.

The stretching may be performed under wet conditions.

The stretching may be performed at a stretching ratio of at least two times or more, for example, in a range of about 2 times to about 5 times. In the above range, there may be an effect of easier overall stretching ratio control and stretching process handling.

In the above stretching, it may be advantageous that the stretching temperature is within the range of the crystal dispersion temperature (Tcd) of the first resin to Tcd+30 °C, for example within the range of Tcd+5 °C to Tcd+28 °C, and for example within the range of Tcd+10 °C to Tcd+26 °C. When the stretching temperature is within the above range, film rupture due to resin stretching is reduced or suppressed, enabling high-magnification stretching. Here, the crystal dispersion temperature (Tcd) refers to a value obtained by measuring the temperature characteristics of dynamic viscoelasticity according to ASTM D4065. The stretching temperature may be, for example, about 90 °C or higher and about 130 °C or lower.

### Manufacture of Porous Substrate

A porous substrate is manufactured by removing the film-forming solvent and the oil from the second film. The order of removing the film-forming solvent and the oil may not be particularly limited.

The film-forming solvent is removed using a washing solvent. The first resin, for example, a polyolefin-based resin, is phase-separated from the film-forming solvent, so when the film-forming solvent is removed, a porous substrate may be obtained, which is composed of or include fibrils forming a fine three-dimensional network structure and has three-dimensionally irregularly interconnected holes (pores). Since the washing solvent and a method for removing the film-forming solvent using the same are known, their description is omitted.

Oil and the like included in the resin solution may be removed after the stretching. In one example embodiment, when the oil is liquid paraffin, the oil may be removed by methylene chloride.

Subsequently, the microporous film from which the film-forming solvent has been removed is dried by a heat drying method or an air drying method. The drying temperature is for example lower than the crystal dispersion temperature of the resin, and in particular, is for example lower than the Ted by about 5 °C or more. Drying is for example performed until the residual washing solvent becomes about 5 mass % or less based on 100 mass % (dry weight) of the casting film, and for example until the residual washing solvent becomes about 3 mass % or less. When the residual washing solvent is within the above range, the porosity is maintained when the stretching process and heat treatment process of the casting film are performed, and the deterioration of permeability is reduced or suppressed.

Subsequently, heat treatment may be performed on the porous substrate after drying. As a heat treatment method, heat setting treatment and/or heat relaxation treatment may be used. Heat setting treatment is a heat treatment that heats the film while maintaining its dimensions in the TD without change. Heat relaxation treatment is a treatment that causes the film to thermally shrink in the MD and/or TD during heating. It may be advantageous to perform the heat setting treatment by a tenter or roll method. The heat treatment temperature is for example within the range of the Tcd to Tm (melting temperature) of the resin.

### Porous Substrate

Another example embodiment includes a porous substrate manufactured by the manufacturing method.

The porous substrate may be manufactured by the manufacturing method.

The porous substrate includes a porous matrix including a first resin, and a filler impregnated into the matrix, wherein the filler may include a linear filler and the linear filler may include the first resin. The first resin, the linear filler, and the first resin forming the linear filler may be substantially the same as described above.

The porous substrate may satisfy the above-described puncture strength, thermal shrinkage rate, air permeability, and tensile strength.

In the porous substrate, the matrix may be included in an amount in a range of about 50 wt % to about 80 wt % for example 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 wt %, and the filler may be included in an amount in a range of about 20 wt % to about 50 wt %, for example 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 wt %.

The porous substrate may be used as a substrate of a separator for a rechargeable battery to improve the reliability and safety of the battery.

### Separator for Rechargeable Battery

Another example embodiment includes a separator for a rechargeable battery including the porous substrate.

In one example embodiment, the separator for a rechargeable battery may be the porous substrate alone.

In another example embodiment, the separator for a rechargeable battery may include the porous substrate and a coating layer including an organic material, an inorganic material, or a combination thereof located on one side or both sides of the porous substrate.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be present as a mixture in one coating layer or may be present in a form in which a coating layer including an organic material and a coating layer including an inorganic material are stacked.

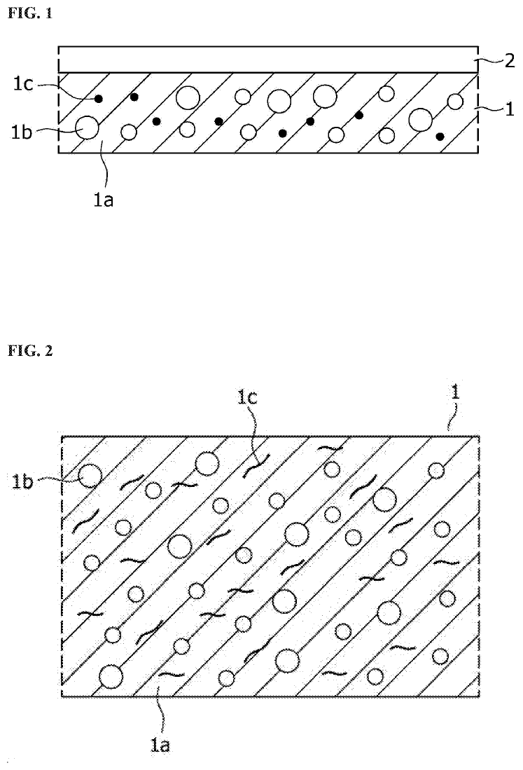

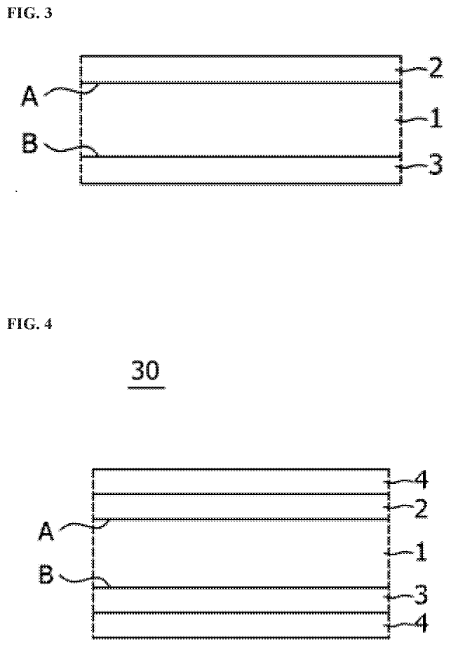

FIG. 1 is a cross-sectional view of a separator for a rechargeable battery according to one example embodiment, and FIG. 2 is a plan view of a porous substrate according to one example embodiment.

The separator may include a porous substrate 1 and a coating layer 2 formed on a first surface of the porous substrate 1. The porous substrate 1 may include a matrix 1a including a first resin (not shown) and pores 1b, and a linear filler 1c impregnated into the matrix 1a.

### Disclosure According to Second Example Embodiment

According to one example embodiment, a separator for a rechargeable battery may be used in a rechargeable lithium battery. However, the present disclosure is not limited thereto, and the separator may be applicable to metal rechargeable batteries such as sodium rechargeable batteries in addition to the rechargeable lithium batteries.

According to one example embodiment, the separator for a rechargeable battery includes a porous substrate and a coating layer formed on at least one surface of the porous substrate.

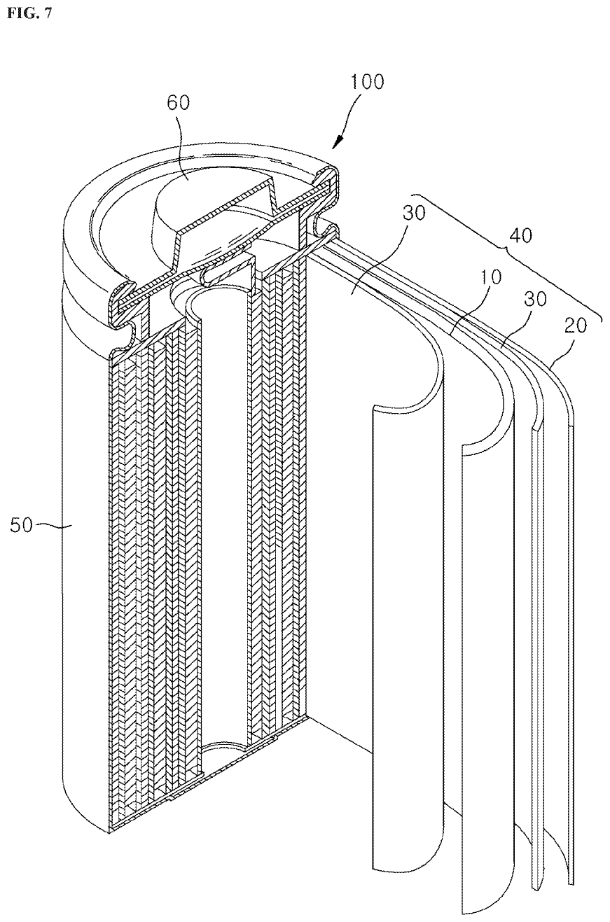

FIG. 4 is a cross-sectional view of a separator for a rechargeable battery according to one example embodiment. Referring to FIG. 4, the separator may include the porous substrate, a coating layer 4 formed on a first surface of the porous substrate, and a coating layer 4 formed on a second surface of the porous substrate.

The coating layer 2 in the separator for a rechargeable battery may be or include an aqueous coating layer.

Here, the term ‘aqueous coating layer’ may mean a coating layer including an aqueous binder.

Here, ‘aqueous binder’ may mean a binder that dissolves in an aqueous solvent such as water. The aqueous coating layer does not readily dissolve in a non-aqueous organic solvent as an electrolyte, so the strength of the separator may not decrease even during charging and discharging of the battery. For example, the aqueous coating layer can improve the manufacturing processibility of the separator because the aqueous coating layer does not require the use of an organic solvent in the preparation of the coating layer.

The porous substrate in the separator for a rechargeable battery has remarkably desired or improved adhesion to the aqueous coating layer. Therefore, the separator for a rechargeable battery may have remarkably low thermal shrinkage in each of a machine direction and a transverse direction of the porous substrate, thereby increasing the reliability and safety of the battery.

In one example embodiment, the porous substrate or the separator may have a thermal shrinkage of about 6% or less in each of the machine direction (MD) and transverse direction (TD) of the porous substrate. In the above range, the heat resistance of the battery may be improved.

In addition, the porous substrate in the separator for a rechargeable battery has improved electrolyte wettability. The coating layer in the separator may come into direct contact with the electrolyte compared to the porous substrate. As a method for improving the electrolyte wettability of the separator, adjusting a composition of the coating layer has been considered. However, this method improves electrolyte wettability only on the surface of the separator, namely the coating layer, and thus could not enhance electrolyte impregnability into the interior of the separator where lithium ions (Li⁺) actually migrate, namely the porous substrate. On the other hand, the separator for a rechargeable battery according to one example embodiment can improve the output and capacity of the battery by enhancing the electrolyte wettability of the porous substrate.

Hereinafter, a separator for a rechargeable battery according to one example embodiment is described in detail.

### Porous Substrate

The porous substrate includes an intermediate layer, a first surface layer formed on a first surface of the intermediate layer, and a second surface layer formed on a second surface of the intermediate layer. The first surface and the second surface may face each other, and the first surface layer and the second surface layer may face each other.

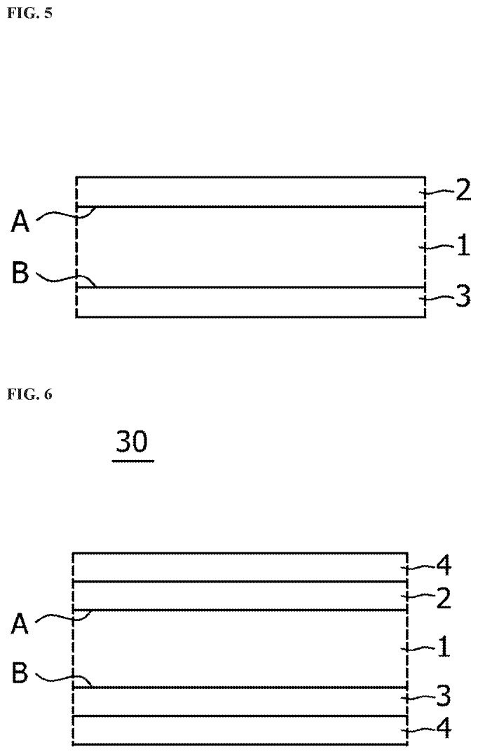

In one example embodiment, the porous substrate may be or include a triple layer. FIG. 3 is a cross-sectional view of a porous substrate according to one example embodiment. Referring to FIG. 3, the porous substrate may include an intermediate layer 1, a first surface layer 2 located on a first surface A of the intermediate layer 1, and a second surface layer 3 located on a second surface B of the intermediate layer 1.

The porous substrate can simultaneously provide desired or improved adhesion to an aqueous coating layer and desired or improved electrolyte wettability. Conventionally, a method of increasing adhesion to a coating layer by surface-treating a porous substrate, for example, by corona treatment, has been considered. However, this method may change the properties of the porous substrate due to corona treatment, and electrolyte wettability may be poor depending on the material of the porous substrate.

The porous substrate includes an intermediate layer, a first surface layer, and a second surface layer in the thickness direction. The porous substrate includes at least three layers in the thickness direction: an intermediate layer, a first surface layer, and a second surface layer. This configuration enables the simultaneous provision of desired or improved adhesion between the porous substrate and the aqueous coating layer, as well as desired or improved electrolyte wettability.

This is described first with the intermediate layer, the first surface layer, and the second surface layer, and then in more detail below.

### Intermediate Layer

Here, the term ‘intermediate layer’ only means that the layer is located in the middle in the thickness direction of a porous substrate, and does not mean that the function of the layer is intermediate relative to a first surface layer and a second surface layer.

The intermediate layer includes a mixture of a polyolefin-based resin; and a copolymer of a monomer mixture including a range of about 1 wt % to about 40 wt % of a monomer having a hydrophilic group.

In one example embodiment, the intermediate layer may be or include a film including or consisting of the mixture. In one example embodiment, the intermediate layer may be a stretched or unstretched film including or consisting of the mixture.

While an intermediate layer consisting of only the polyolefin-based resin can increase the mechanical strength and porosity of the separator, such an intermediate layer lacks hydrophilic groups, which may lower the electrolyte impregnability of the separator. An intermediate layer consisting of only the copolymer may have poor stretchability compared to the polyolefin-based resin due to the monomer having a hydrophilic group, which may lower the overall physical properties of the separator.

Merely adjusting the ratio of the polyolefin-based resin and the copolymer in the mixture may not improve adhesion between the porous substrate and the aqueous coating layer or electrolyte impregnability.

The copolymer is a copolymer of a monomer mixture including a range of about 1 wt % to about 40 wt % of a monomer having a hydrophilic group.

When the monomer having a hydrophilic group is included in the monomer mixture in an amount of less than about 1 wt %, the content of the monomer having a hydrophilic group in the copolymer may be too low, which may result in the hydrophobic nature of the intermediate layer becoming stronger and electrolyte impregnability being lowered. For example, the interfacial adhesion between the intermediate layer and the first surface layer and the interfacial adhesion between the intermediate layer and the second surface layer may be reduced, which may cause delamination or lifting between the intermediate layer and the first surface layer, and delamination or lifting between the intermediate layer and the second surface layer during the manufacture of the porous substrate.

When the monomer mixture includes more than 40% by weight of the monomer having a hydrophilic group, the content of monomers other than the monomer having a hydrophilic group, for example, olefin-based monomers, may become excessively low. This can lead to poor blending between the copolymer and the polyolefin-based resin, making it challenging to manufacture the intermediate layer and potentially degrading the overall physical properties of the porous substrate.

In one example embodiment, the monomer having a hydrophilic group may be included in the monomer mixture in an amount in a range of about 2 wt % to about 20 wt %. In the above range, electrolyte impregnability can be further improved.

In one example embodiment, the monomer having a hydrophilic group may be included in the monomer mixture in an amount in a range of about 5 wt % to about 15 wt %. In the above range, thermal and mechanical properties can be significantly superior to the thermal and mechanical properties of an intermediate layer formed from a monomer mixture including about 1 wt % or more and less than about 5 wt % of the monomer having a hydrophilic group. For example, in the above range, compatibility between the copolymer and the polyolefin-based resin may be better than the compatibility of an intermediate layer formed from a monomer mixture including more than about 15 wt % and about 40 wt % or less of the monomer having a hydrophilic group.

The monomer having a hydrophilic group may be or include a monomer having a hydrophilic group within the monomer itself, or may be or include a monomer having higher hydrophilicity than the olefin-based monomer described below.

Here, “high hydrophilicity” may refer to a higher value compared to the olefin-based monomer when measuring the hydrophile lipophile balance (HLB). HLB may be measured by conventional methods known to those skilled in the art.

Here, the hydrophilic group may refer to a hydroxyl group (—OH), a carboxylic acid group (—COOH), and the like.

In one example embodiment, the monomer having a hydrophilic group may include one or more of a (meth)acrylic acid ester having at least one of an alkyl group having a range of 1 carbon atom to about 5 carbon atoms, an alcohol-based compound having (meth)acrylic acid, a vinyl group, or an allyl group, and an ester-based compound having a vinyl group or an allyl group. For example, the monomer having a hydrophilic group may include one or more of methyl (meth)acrylate, ethyl (meth)acrylate, N-propyl (meth)acrylate, N-butyl (meth)acrylate, (meth)acrylic acid, vinyl alcohol, allyl alcohol, and vinyl acetate. For example, the monomer having a hydrophilic group may be or include one or more of ethyl (meth)acrylate and N-propyl (meth)acrylate.

The olefin-based monomer may be or include an alpha-olefin-based monomer. The olefin-based monomer may include one or more of ethylene, propylene, 1-butene, 1-pentene, 1-hexene, 1,4-methylpentene, 1-octene, and styrene.

In one example embodiment, the olefin-based monomer may be included in the monomer mixture in an amount in a range of about 60 wt % to about 99 wt %. In the above range, the mechanical properties of the porous substrate may be desired or improved, and fracture may be reduced during stretching. For example, the olefin-based monomer may be included in an amount in a range of about 80 wt % to about 98 wt %, or 85 wt % to 95 wt %, and may be mixed with the monomer having a hydrophilic group within the above range.

In one example embodiment, the total amount of the monomer having a hydrophilic group and the olefin-based monomer may be about 95 wt % or more, for example, a range of about 95 wt % to about 100 wt %, or 100 wt %, of the monomer mixture. In the above range, the adhesion between the first surface layer and the second surface layer is desired or improved, so that separation can be reduced.

The copolymer may have a weight average molecular weight of about 1 million g/mol or more, for example, a range of about 1 million g/mol to about 1.5 million g/mol. In the above range, fracture during stretching may be low or minimal.

Here, the weight average molecular weight may be obtained as a polystyrene-converted value by, e.g., gel permeation chromatography.

The copolymer may be prepared by a conventional polymerization method known to those skilled in the art.

The polyolefin-based resin may be or include a polymer of an olefin-based monomer. For example, the polyolefin-based resin may include one or more of a polyethylene resin and a polypropylene resin. For example, the polyolefin-based resin may be or include a polyethylene resin.

The polyolefin-based resin may have a weight average molecular weight of about 1 million g/mol or more, for example, a range of about 1 million g/mol to about 1.5 million g/mol. In the above range, fracture during stretching for the simultaneous manufacture of the first surface layer, the intermediate layer, and the second surface layer may be reduced.

The polyolefin-based resin may have higher crystallinity than the copolymer of each of the first surface layer and the second surface layer. Therefore, when manufacturing the porous substrate by stretching, it is possible to reduce or prevent the fracture of the first surface layer and the second surface layer.

The polyolefin-based resin may be included in the mixture in an amount in a range of about 60 wt % to about 95 wt % and the copolymer may be included in an amount in a range of about 5 wt % to about 40 wt %. In the above range, it can be possible to provide an intermediate layer with improved electrolyte impregnability. For example, the polyolefin-based resin may be included in an amount in a range of about 70 wt % to about 95 wt %, and the copolymer may be included in an amount in a range of about 5 wt % to about 30 wt %. In the above range, the effect of improving the electrolyte impregnability of the intermediate layer can be significant.

In one example embodiment, the total amount of the polyolefin-based resin and the copolymer may be about 95 wt % or more, for example, a range of about 95 wt % to about 100 wt %, or 100 wt %, of the mixture. In the above range, the effect of improving the electrolyte impregnability of the intermediate layer can be significant.

The intermediate layer may have a porous structure. This can facilitate the movement of lithium ions during charging and discharging of the battery. The porous structure can be implemented by a conventional wet or dry film forming method for the intermediate layer or the porous substrate.

The intermediate layer is thicker than each of the first surface layer and the second surface layer, and may have a thickness of about 30 μm or less, for example, more than about 0 μm and about 30 μm or less, for example, 5 μm to 25 μm. In the above range, the intermediate layer can be used in a porous substrate.

### First Surface Layer

The first surface layer is formed on the first surface of the intermediate layer. In one example embodiment, the first surface layer is located at the outermost surface of the porous substrate and may come into direct contact with the electrolyte in the battery.

The first surface layer can improve the electrolyte impregnability of the porous substrate and increase the adhesion between the porous substrate and the aqueous coating layer. In this regard, the first surface layer includes a copolymer of a monomer mixture including a range of about 1 wt % to about 40 wt % of a monomer having a hydrophilic group. In one example embodiment, the first surface layer may be or include a film including or consisting of the copolymer. In one example embodiment, the first surface layer may be a stretched or unstretched film including or consisting of the copolymer.

The copolymer is a copolymer of a monomer mixture including a range of about 1 wt % to about 40 wt % of a monomer having a hydrophilic group.

When the monomer having a hydrophilic group is included in the monomer mixture in an amount of less than about 1 wt %, the content of the monomer having a hydrophilic group in the copolymer may be too low, which may result in the hydrophobic nature of the first surface layer becoming stronger and electrolyte impregnability and the adhesion to the aqueous coating layer being lowered. For example, the interfacial adhesion between the intermediate layer and the first surface layer may be reduced, which may cause delamination or lifting between the intermediate layer and the first surface layer during the manufacture of the porous substrate.

When the monomer mixture includes more than about 40% by weight of the monomer having a hydrophilic group, the content of monomers other than the monomer having a hydrophilic group, for example, olefin-based monomers, becomes excessively low. This may make the manufacture of the first surface layer challenging and may result in poor overall properties of the porous substrate.

In one example embodiment, the monomer having a hydrophilic group may be included in the monomer mixture in an amount in a range of about 2 wt % to about 20 wt %. In the above range, the adhesion to the aqueous coating layer can be further improved.

In one example embodiment, the monomer having a hydrophilic group may be included in the monomer mixture in an amount in a range of about 5 wt % to about 15 wt %. In the above range, thermal and mechanical properties can be significantly superior to those of a first surface layer formed from a monomer mixture including about 1 wt % or more and less than about 5 wt % of the monomer having a hydrophilic group. For example, in the above range, adhesion to the intermediate layer may be better than that of the first surface layer formed from a monomer mixture including more than about 15 wt % and about 40 wt % or less of the monomer having a hydrophilic group.

The monomer having a hydrophilic group may be or include a monomer having a hydrophilic group within the monomer itself, or may be or include a monomer having higher hydrophilicity than the olefin-based monomer described below.

The monomer having a hydrophilic group may be selected and used from the detailed types described for the intermediate layer. For example, the monomer having a hydrophilic group may include one or more of methyl (meth)acrylate, ethyl (meth)acrylate, N-propyl (meth)acrylate, N-butyl (meth)acrylate, (meth)acrylic acid, vinyl alcohol, allyl alcohol, and vinyl acetate. For example, the monomer having a hydrophilic group may be or include one or more of ethyl (meth)acrylate and N-propyl (meth)acrylate.

The monomer mixture may further include an olefin-based monomer.

The olefin-based monomer may be selected and used from the detailed types described for the intermediate layer. For example, the olefin-based monomer may be ethylene.

In one example embodiment, the olefin-based monomer may be included in the monomer mixture in an amount in a range of about 60 wt % to about 99 wt %. In the above range, the mechanical properties of the porous substrate may be desired or improved and fracture may be reduced during stretching. For example, the olefin-based monomer may be included in an amount in a range of about 80 wt % to about 98 wt %, or 85 wt % to 95 wt %, and may be mixed with the monomer having a hydrophilic group within the above range.

In one example embodiment, the total amount of the monomer having a hydrophilic group and the olefin-based monomer may be about 95 wt % or more, for example, a range of about 95 wt % to about 100 wt %, or 100 wt %, of the monomer mixture. In the above range, adhesion to the aqueous coating layer and electrolyte impregnability can be desired or improved.

The copolymer may have a weight average molecular weight of about 1 million g/mol or more, for example, a range of about 1 million g/mol to about 1.5 million g/mol. In the above range, fracture during stretching may be low or minimal.

The copolymer may have lower crystallinity than the polyolefin-based resin of the intermediate layer.

The first surface layer may have a porous structure. This can facilitate the movement of lithium ions during charging and discharging of the battery. The porous structure can be implemented by a conventional wet or dry film forming method for the intermediate layer or the porous substrate.

The first surface layer may have a thickness of about 5 μm or less, for example, more than about 0 μm and about 5 μm or less, for example, more than 0 μm and 2 μm or less. In the above range, the first surface layer can be used in a porous substrate.

### Second Surface Layer

The second surface layer is formed on the second surface of the intermediate layer. In one example embodiment, the second surface layer is located at the outermost surface of the porous substrate and may come into direct contact with the electrolyte in the battery.

The second surface layer can improve the electrolyte impregnability of the porous substrate and increase the adhesion between the porous substrate and the aqueous coating layer. In this regard, the second surface layer includes a copolymer of a monomer mixture including a range of about 1 wt % to about 40 wt % of a monomer having a hydrophilic group. In one example embodiment, the second surface layer may be or include a film including or consisting of the copolymer. In one example embodiment, the second surface layer may be a stretched or unstretched film including or consisting of the copolymer.

When the monomer having a hydrophilic group is included in the monomer mixture in an amount of less than about 1 wt %, the content of the monomer having a hydrophilic group in the copolymer may be too low, which may result in the hydrophobic nature of the second surface layer becoming stronger and electrolyte impregnability and the adhesion to the aqueous coating layer being lowered. For example, the interfacial adhesion between the intermediate layer and the second surface layer may be reduced, which may cause delamination or lifting between the intermediate layer and the second surface layer during the manufacture of the porous substrate.

When the monomer mixture includes more than about 40% by weight of the monomer having a hydrophilic group, the content of monomers other than the monomer having a hydrophilic group, for example, olefin-based monomers, becomes excessively low. This may make the manufacture of the second surface layer challenging and may result in poor overall properties of the porous substrate.

In one example embodiment, the monomer having a hydrophilic group may be included in the monomer mixture in an amount in a range of about 2 wt % to about 20 wt %. In the above range, the adhesion to the aqueous coating layer can be further improved.

In one example embodiment, the monomer having a hydrophilic group may be included in the monomer mixture in an amount in a range of about 5 wt % to about 15 wt %. In the above range, thermal and mechanical properties can be significantly superior to those of a second surface layer formed from a monomer mixture including about 1 wt % or more and less than about 5 wt % of the monomer having a hydrophilic group. For example, in the above range, adhesion to the intermediate layer may be better than the adhesion of the first surface layer formed from a monomer mixture including more than about 15 wt % and about 40 wt % or less of the monomer having a hydrophilic group.

The monomer mixture may further include an olefin-based monomer.

Details of the monomer having a hydrophilic group and the olefin-based monomer are substantially the same as those described for the first surface layer and thus are omitted.

The copolymer may have lower crystallinity than the polyolefin-based resin of the intermediate layer.

The second surface layer may have a porous structure.

The second surface layer may have a thickness of about 5 μm or less, for example, more than about 0 μm and about 5 μm or less, for example, more than 0 μm and 2 μm or less. In the above range, the second surface layer can be used in a porous substrate.

The porous substrate includes at least three layers in the thickness direction, namely the first surface layer, the intermediate layer, and the second surface layer, which are sequentially stacked. Through this, the separator can simultaneously provide desired or improved adhesion between the porous substrate and the aqueous coating layer and desired or improved electrolyte wettability.

A separator having a porous substrate consisting of only the intermediate layer may have minor improvement of adhesion to the aqueous coating layer because the porous substrate does not have sufficient hydrophilic groups.

A separator having a porous substrate consisting of only the first surface layer or the second surface layer has desired or improved adhesion to the aqueous coating layer and electrolyte wettability, but the crystallinity of the copolymer is lower than the crystallinity of the polyolefin-based resin, thus stretchability is poor, making it challenging to manufacture a porous substrate.

In one example embodiment, the content of the monomer having a hydrophilic group in the monomer mixture for the copolymer of the intermediate layer may be in a range of about 0 wt % to about 5 wt % higher than the content of the monomer having a hydrophilic group for the copolymer of each of the first surface layer or the second surface layer. In the above range, ions that enter the first surface layer or the second surface layer can also be impregnated into the intermediate layer.

The porous substrate may have a thickness of about 20 μm or less, for example, more than about 0 μm and about 20 μm or less, or 1 μm to 20 μm.

### Manufacture of Porous Substrate

The porous substrate may be manufactured by a conventional method known to those skilled in the art.

The porous substrate may be manufactured by separately manufacturing an intermediate layer, a first surface layer, and a second surface layer, and then direct laminating and pressing them. The intermediate layer, the first surface layer, and the second surface layer may each be manufactured by a wet film forming method or a dry film forming method.

The porous substrate may be manufactured by a conventional porous film forming method by introducing a melt for the intermediate layer, a melt for the first surface layer, and a melt for the second surface layer into a co-extruder and then co-extruding them.

### Coating Layer

The coating layer may include an aqueous coating layer.

The aqueous coating layer may include an aqueous binder and a filler. The aqueous binder may include a binder having repeating units that are soluble in an aqueous solvent such as water. The aqueous binder is a heat-resistant binder and may further reduce the thermal shrinkage of the separator.

According to one example embodiment, the aqueous binder may include a (meth)acrylic binder having a sulfonic acid, a sulfonate, or a sulfonate functional group. A (meth)acrylic binder having a sulfonic acid or a sulfonate functional group is an aqueous binder that can reduce the resistance of the separator and enhance its heat resistance. For example, the (meth)acrylic binder having a sulfonic acid or a sulfonate functional group may have desired or improved adhesion to the porous substrate as described below.

In one example embodiment, the aqueous binder may be or include a copolymer of a monomer mixture including a monomer having at least one of a (meth)acrylamidosulfonic acid, a (meth)acrylamidosulfonate, or a (meth)acrylamidosulfonate functional group. For example, the monomer may include one or more of 2-(meth)acrylamido-2-methylpropane sulfonic acid, 2-(meth)acrylamido-2-methylpropane sulfonate, or a 2-(meth)acrylamido-2-methylpropane sulfonate functional group. The monomer may be included in the monomer mixture in an amount in a range of about 1 mol % to about 75 mol %, for example 1 to 10 mol %, 25 to 70 mol %, 20 to 65 mol %, 30 to 65 mol %, or 30 to 60 mol %.

The monomer mixture may further include one or more comonomers such as or including at least one of a (meth)acrylamide monomer (e.g., (meth)acrylamide and the like), (meth)acrylic acid or (meth)acrylate (e.g., (meth)acrylic acid and the like), a (meth)acrylic monomer having a cyano group (e.g., (meth)acrylonitrile and the like), and a (meth)acrylic monomer having a hydroxyl group (e.g., 2-hydroxyethyl (meth)acrylate and the like). The comonomer may provide additional functionality to the separator.

The filler may be or include an inorganic filler, an organic filler, an organic-inorganic composite filler, or a combination thereof. The inorganic filler may be or include a ceramic material capable of improving heat resistance. The inorganic filler may include, for example, at least one of a metal oxide, a metalloid oxide, a metal fluoride, a metal hydroxide, or a combination thereof. The inorganic filler may include, for example, at least one of alumina (e.g., Al₂O₃), SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include, but is not limited to, at least one of an acryl compound, an imide compound, an amide compound, or a combination thereof. The organic filler may have a core-shell structure, but is not limited thereto.

The filler may be one or more of boehmite and alumina.

The filler may be spherical, platy, cubic, or amorphous. For example, the filler may have a plate shape.

The filler may have an average particle diameter D50 of about 0.5 μm or less, for example, about 0.4 μm or less, or in a range of about 0.2 μm to about 0.35 μm. In the above range, there may be an effect of improving thermal shrinkage.

The aqueous binder and filler in the aqueous coating layer may be included in a weight ratio in a range of about 1:10 to about 1:50, for example, a weight ratio of 1:20 to 1:30. In the above range, there may be an effect of further reducing the thermal shrinkage of the separator.

The aqueous coating layer may further include an adhesive binder.

The adhesive binder may include one or more of an aqueous adhesive binder and an organic adhesive binder. For example, the adhesive binder may be or include an aqueous adhesive binder. The adhesive binder may include one or more of a polyvinylidene fluoride copolymer such as polymethyl methacrylate (PMMA), polyvinylidene fluoride (PVDF), and polyvinylidene fluoride-hexafluoropropylene (PVDF-HFP).

The coating layer may have a thickness in a range of about 0.5 μm to about 2.0 μm, for example, 0.5 to 1.5 μm. In the above range, the porous substrate can be used in the separator.

The coating layer may be prepared by a conventional method known to those skilled in the art.

### Disclosure According to Third Example Embodiment

According to one example embodiment, the separator for a rechargeable battery includes a porous substrate, and a coating layer formed on at least one surface of the porous substrate.

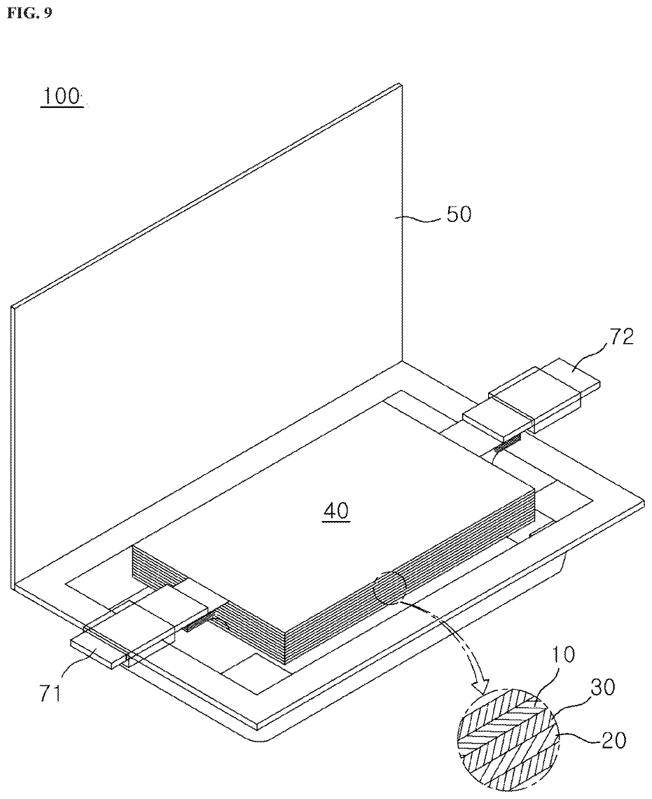

FIG. 6 is a cross-sectional view of a separator for a rechargeable battery according to one example embodiment. Referring to FIG. 6, the separator may include a porous substrate, a coating layer 4 formed on a first surface A of the porous substrate, and a coating layer 4 formed on a second surface B of the porous substrate.

The coating layer 4 in the separator for a rechargeable battery may be or include an aqueous coating layer.

Here, the term ‘aqueous coating layer’ may mean a coating layer including an aqueous binder.

Here, ‘aqueous binder’ may mean a binder that dissolves in an aqueous solvent such as water. The aqueous coating layer does not readily dissolve in a non-aqueous organic solvent as an electrolyte, so the strength of the separator may not decrease even during charging and discharging of the battery. For example, the aqueous coating layer can improve the manufacturing processibility of the separator because the aqueous coating layer does not require the use of an organic solvent in the preparation of the coating layer.

The porous substrate in the separator for a rechargeable battery has remarkably desired or improved adhesion to the aqueous coating layer. Therefore, the separator for a rechargeable battery may have a remarkably low thermal shrinkage in each of a machine direction and a transverse direction of the porous substrate, thereby increasing the reliability and safety of the battery.

In one example embodiment, the porous substrate or the separator may have a thermal shrinkage of about 12% or less in each of the machine direction (MD) and transverse direction (TD) of the porous substrate. In the above range, the heat resistance of the battery may be improved.

In addition, the porous substrate in the separator for a rechargeable battery has improved electrolyte wettability or electrolyte impregnability. The coating layer in the separator may come into direct contact with the electrolyte compared to the porous substrate. As a method for improving the electrolyte wettability of the separator, adjusting a composition of the coating layer has been considered. However, since this method improves electrolyte wettability only on the surface of the separator, namely the coating layer, and thus could not enhance electrolyte impregnability into the interior of the separator where lithium ions (Li⁺) actually migrate, namely the porous substrate. On the other hand, the separator for a rechargeable battery according to one example embodiment can improve the output and capacity of the battery by enhancing the electrolyte wettability of the porous substrate.

Hereinafter, a separator for a rechargeable battery according to one example embodiment is described in detail.

### Porous Substrate

The porous substrate includes an intermediate layer, a first surface layer formed on a first surface of the intermediate layer, and a second surface layer formed on a second surface of the intermediate layer. The first surface and the second surface may face each other, and the first surface layer and the second surface layer may face each other.

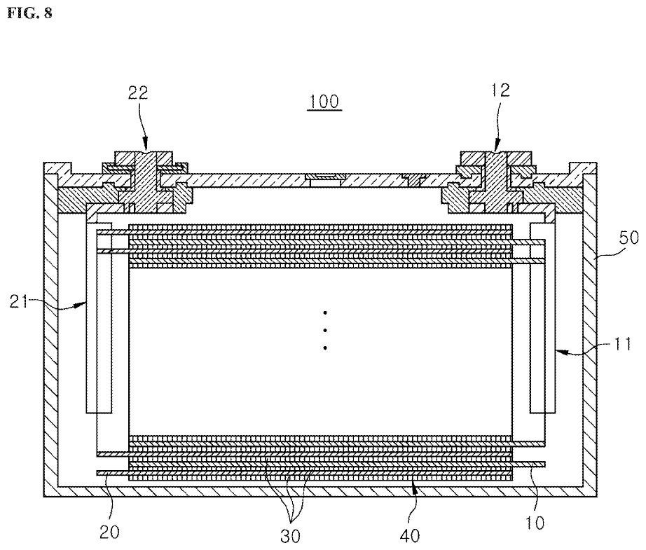

In one example embodiment, the porous substrate may be or include a triple layer. FIG. 5 is a cross-sectional view of a porous substrate according to one example embodiment. Referring to FIG. 5, the porous substrate may include an intermediate layer 1, a first surface layer 2 located on a first surface A of the intermediate layer 1, and a second surface layer 3 located on a second surface B of the intermediate layer 1.

The porous substrate can simultaneously provide desired or improved adhesion to an aqueous coating layer and desired or improved electrolyte wettability. Conventionally, a method of increasing adhesion to a coating layer by surface-treating a porous substrate, for example, by corona treatment, has been considered. However, this method may change the properties of the porous substrate due to corona treatment, and electrolyte wettability may be poor depending on the material of the porous substrate.

The porous substrate includes an intermediate layer, a first surface layer, and a second surface layer in the thickness direction. The porous substrate includes at least three layers in the thickness direction: an intermediate layer, a first surface layer, and a second surface layer. This configuration enables the simultaneous provision of desired or improved adhesion between the porous substrate and the aqueous coating layer, as well as remarkably desired or improved electrolyte wettability.

### Intermediate Layer

Here, the term ‘intermediate layer’ only means that the layer is located in the middle in the thickness direction of a porous substrate, and does not mean that the function of the layer is intermediate relative to a first surface layer and a second surface layer.

The intermediate layer includes a mixture of a polyolefin-based resin and nylon. The intermediate layer may facilitate improvements in electrolyte impregnability and heat resistance by including a mixture of the polyolefin-based resin and nylon.

In one example embodiment, the intermediate layer may be or include a film including or consisting of the mixture. In one example embodiment, the intermediate layer may be a stretched or unstretched film including or consisting of the mixture.

The polyolefin-based resin may be or include a polymer of an olefin-based monomer. For example, the polyolefin-based resin may include one or more of a polyethylene resin and a polypropylene resin. For example, the polyolefin-based resin may be or include a polyethylene resin.

The polyolefin-based resin may have a weight average molecular weight of about 1 million g/mol or more, for example, a range of about 1 million g/mol to about 1.5 million g/mol. In the above range, fracture during stretching for the simultaneous manufacture of the first surface layer, the intermediate layer, and the second surface layer may be reduced.

Here, the weight average molecular weight may be obtained as a polystyrene-converted value by gel permeation chromatography.

The polyolefin-based resin may have higher crystallinity than the copolymer of each of the first surface layer and the second surface layer. Therefore, when manufacturing the porous substrate by stretching, it is possible to reduce or prevent the fracture of the first surface layer and the second surface layer.

The nylon is or includes a polyamide-based resin. The nylon was included together with the polyolefin-based resin, thereby facilitating improvements in electrolyte impregnability and heat resistance.

The nylon can improve the heat resistance of the porous substrate by improving the heat resistance of the intermediate layer. For example, the nylon is the same resin as the nylon located in each of the first surface layer and the second surface layer, and can further increase the bonding strength between the intermediate layer and the first surface layer and the intermediate layer and the second surface layer, and can further increase the electrolyte impregnability of the porous substrate by not compromising the movement of ions transmitted by each of the first surface layer and the second surface layer.

In one example embodiment, the nylon may be nylon 6, 3, 4, 7, 8, 9, 11, 12, 6/6, 4/6, 6/8, or 6/10. For example, the nylon may be nylon 12.

The polyolefin-based resin in the intermediate layer may be included in an amount in a range of 60 wt % to about 95 wt %, and the nylon may be included in an amount in a range of about 5 wt % to about 40 wt %. In the above range, it can be possible to provide an intermediate layer with improved electrolyte impregnability. For example, the polyolefin-based resin in the intermediate layer may be included in an amount in a range of about 70 wt % to about 95 wt %, and the nylon may be included in an amount in a range of about 5 wt % to about 30 wt %. In the above range, the effect of improving the electrolyte impregnability of the intermediate layer can be significant. For example, the polyolefin-based resin in the intermediate layer may be included in an amount in a range of about 60 wt % to about 95 wt %, 70 wt % to 95 wt %, or 60 wt % to 90 wt %. For example, the nylon in the intermediate layer may be included in an amount in a range of about 5 wt % to about 40 wt %, or 5 wt % to 30 wt %.

In one example embodiment, the total amount of the polyolefin-based resin and the nylon may be about 90 wt % or more, for example, a range of about 90 wt % to about 100 wt %, or 100 wt %, of the mixture. In the above range, the effect of improving the electrolyte impregnability of the intermediate layer can be significant.

The intermediate layer may further include a surfactant.

The surfactant can increase the affinity between the polyolefin-based resin and the nylon, so that the polyolefin-based resin and the nylon in the intermediate layer are blended and do not separate from each other. For example, the surfactant can increase the affinity between the polyolefin-based resin and the nylon of each of the first surface layer and the second surface layer in the intermediate layer, thereby reducing or preventing separation between the intermediate layer and the first surface layer or separation between the intermediate layer and the second surface layer during the manufacture of the porous substrate.

The surfactant may be selected from common surfactants known to those skilled in the art.

In one example embodiment, the surfactant may include one or more of an ionic surfactant including one or more of a cationic surfactant, an anionic surfactant, and a zwitterionic surfactant, and a nonionic surfactant.

In one example embodiment, the surfactant is a copolymer of a monomer mixture including an olefin-based monomer and a comonomer.

The olefin-based monomer can provide high compatibility with the polyethylene resin. The comonomer may be copolymerized with the olefin-based monomer, and can provide high compatibility with the nylon.

The olefin-based monomer may be or include an alpha-olefin-based monomer. The olefin-based monomer may include one or more of ethylene, propylene, 1-butene, 1-pentene, 1-hexene, 1,4-methylpentene, 1-octene, and styrene.

In one example embodiment, the olefin-based monomer may be included in the monomer mixture in an amount in a range of about 60 wt % to about 99 wt %. In the above range, the mechanical properties of the porous substrate may be desired or improved and fracture may be reduced during stretching. For example, the olefin-based monomer may be included in an amount in a range of about 80 wt % to about 98 wt %, or 85 wt % to 95 wt %, and may be mixed with the comonomer within the above range.

The comonomer may include one or more of an alicyclic epoxy-based compound, a halogenated alkyl compound having a range of 1 carbon atom to 30 about carbon atoms, a halogenated polyethylene glycol compound, a halogenated acyl compound having a range of 1 carbon atoms to about 30 carbon atoms, a halogenated acid anhydride having a range of 1 carbon atoms to about 30 carbon atoms, an alkyl ester compound having a range of 1 carbon atom to about 30 carbon atoms, an aliphatic aldehyde-based compound having a range of 1 carbon atom to about 30 carbon atoms, an anhydride compound having a range of 1 carbon atoms to 30 about carbon atoms, and vinyl alcohol.

Here, ‘halogenation’ may mean that one or more hydrogen atoms in the compound are substituted with a halogen, for example, F, Cl, Br or I.

In one example embodiment, the comonomer may include one or more of vinyl alcohol, glycidyl (meth)acrylate, and maleic anhydride.

In one example embodiment, the comonomer may be included in the monomer mixture in an amount in a range of 1 about wt % to about 40 wt %, for example 2 wt % to 20 wt %. In the above range, electrolyte impregnability can be further improved. For example, the comonomer may be included in an amount of 5 wt % to 15 wt %.

In one example embodiment, the total amount of the comonomer and the olefin-based monomer may be about 95 wt % or more, for example, a range of about 95 wt % to about 100 wt %, or 100 wt %, of the monomer mixture. In the above range, the adhesion between the first surface layer and the second surface layer is desired or improved, so that separation can be reduced.

The copolymer may have a weight average molecular weight of about 1 million g/mol or more, for example, a range of about 1 million g/mol to about 1.5 million g/mol. In the above range, fracture during stretching may be low or minimal.

Here, the weight average molecular weight may be obtained as a polystyrene-converted value by, e.g., gel permeation chromatography.

The copolymer may be prepared by a conventional polymerization method known to those skilled in the art.

The surfactant may be included in the intermediate layer in an amount of more than about 0 wt % and about 30 wt % or less, for example, in a range about 1 wt % to about 30 wt %, or 5 wt % to 20 wt %. In the above range, there may be improved compatibility between the polyolefin-based resin and nylon, and no deterioration in the properties of the intermediate layer due to the addition of the surfactant.

The intermediate layer may have a porous structure. This can facilitate the movement of lithium ions during charging and discharging of the battery. The porous structure can be implemented by a conventional wet or dry film forming method for the intermediate layer or the porous substrate.

The intermediate layer may have a thickness of about 30 μm or less, for example, more than about 0 μm and about 30 μm or less, for example, 1 μm to 25 μm. In the above range, the intermediate layer can be used in a porous substrate.

### First Surface Layer

The first surface layer is formed on the first surface of the intermediate layer. In one example embodiment, the first surface layer is located at the outermost surface of the porous substrate and may come into direct contact with the electrolyte in the battery.

The first surface layer can improve the electrolyte impregnability of the porous substrate and increase the adhesion between the porous substrate and the aqueous coating layer. In this regard, the first surface layer includes nylon. In one example embodiment, the first surface layer may be composed of or include nylon.

Since the nylon has the same component as the intermediate layer including the polyolefin-based resin and the nylon, the nylon can increase the bonding strength between the first surface layer and the intermediate layer. For example, the nylon can move ions that have moved into the first surface layer to the intermediate layer, thereby improving the electrolyte impregnability of the porous substrate. For example, since the nylon has desired or improved adhesion to the aqueous coating layer, the thermal shrinkage in each of a machine direction and a transverse direction of the porous substrate can be reduced.

The nylon may be or include one or more of nylon 6, 3, 4, 7, 8, 9, 11, 12, 6/6, 4/6, 6/8, and 6/10. For example, the nylon may be nylon 12.

The first surface layer may have a porous structure. This can facilitate the movement of lithium ions during charging and discharging of the battery. The porous structure can be implemented by a conventional wet or dry film forming method for the intermediate layer or the porous substrate.

The first surface layer may have a thickness of about 10 μm or less, for example, more than 0 μm and about 5 μm or less, for example, more than 0 μm and 2 μm or less. In the above range, the first surface layer can be used in a porous substrate.

### Second Surface Layer

The second surface layer is formed on the second surface of the intermediate layer. In one example embodiment, the second surface layer is located at the outermost surface of the porous substrate, and may come into direct contact with the electrolyte in the battery.

The second surface layer can improve the electrolyte impregnability of the porous substrate and increase the adhesion between the porous substrate and the aqueous coating layer. In this regard, the second surface layer includes nylon. In one example embodiment, the second surface layer may be composed of or include nylon.

Since the nylon has the same component as the intermediate layer including the polyolefin-based resin and the nylon, the nylon can increase the bonding strength between the second surface layer and the intermediate layer. For example, the nylon can move ions that have moved into the first surface layer to the intermediate layer, thereby improving the electrolyte impregnability of the porous substrate. For example, since the nylon has desired or improved adhesion to the aqueous coating layer, the thermal shrinkage in each of a machine direction and a transverse direction of the porous substrate can be reduced.

The nylon may be or include nylon 6, 3, 4, 7, 8, 9, 11, 12, 6/6, 4/6, 6/8, or 6/10. For example, the nylon may be nylon 12.

The second surface layer may have a porous structure. This can facilitate the movement of lithium ions during charging and discharging of the battery. The porous structure can be implemented by a conventional wet or dry film forming method for the intermediate layer or the porous substrate.

The second surface layer may have a thickness of about 10 μm or less, for example, more than 0 μm and about 5 μm or less, for example, more than 0 μm and 2 μm or less. In the above range, the second surface layer can be used in a porous substrate.

The porous substrate may have a thickness of about 20 μm or less, for example, more than 0 μm and about 20 μm or less, or 1 μm to 20 μm.

### Manufacture of Porous Substrate

The porous substrate may be manufactured by a conventional method known to those skilled in the art.

The porous substrate may be manufactured by separately manufacturing an intermediate layer, a first surface layer, and a second surface layer through separate processes, and then direct laminating and pressing them. The intermediate layer, the first surface layer, and the second surface layer may each be manufactured by a wet film forming method or a dry film forming method.

The porous substrate may be manufactured by a conventional porous film forming method by introducing a melt for the intermediate layer, a melt for the first surface layer, and a melt for the second surface layer into a co-extruder and then co-extruding them.

### Coating Layer

The coating layer may include an aqueous coating layer.

The aqueous coating layer may include an aqueous binder and a filler. The aqueous binder may include a binder having repeating units that are soluble in an aqueous solvent such as water. The aqueous binder is a heat-resistant binder and may further reduce the thermal shrinkage of the separator.

According to one example embodiment, the aqueous binder may include at least one of a (meth)acrylic binder having a sulfonic acid, a sulfonate, or a sulfonate functional group. A (meth)acrylic binder having a sulfonic acid or a sulfonate functional group is an aqueous binder that can reduce the resistance of the separator and enhance its heat resistance. For example, the (meth)acrylic binder having a sulfonic acid or a sulfonate functional group may have desired or improved adhesion to the porous substrate as described below.

In one example embodiment, the aqueous binder may be or include a copolymer of a monomer mixture including a monomer having at least one of a (meth)acrylamidosulfonic acid, a (meth)acrylamidosulfonate, or a (meth)acrylamidosulfonate functional group. For example, the monomer may include one or more of 2-(meth)acrylamido-2-methylpropane sulfonic acid, 2-(meth)acrylamido-2-methylpropane sulfonate, or a 2-(meth)acrylamido-2-methylpropane sulfonate functional group. The monomer may be included in the monomer mixture in an amount in a range of about 1 mol % to about 75 mol %, for example 1 to 10 mol %, 25 to 70 mol %, 20 to 65 mol %, 30 to 65 mol %, or 30 to 60 mol %.

The monomer mixture may further include one or more comonomers such as or including at least one of a (meth)acrylamide monomer (e.g., (meth)acrylamide and the like), (meth)acrylic acid or (meth)acrylate (e.g., (meth)acrylic acid and the like), a (meth)acrylic monomer having a cyano group (e.g., (meth)acrylonitrile and the like), and a (meth)acrylic monomer having a hydroxyl group (e.g., 2-hydroxyethyl (meth)acrylate and the like). The comonomer may provide additional functionality to the separator.

The filler may be or include an inorganic filler, an organic filler, an organic-inorganic composite filler, or a combination thereof. The inorganic filler may be or include a ceramic material capable of improving heat resistance. The inorganic filler may include, for example, at least one of a metal oxide, a metalloid oxide, a metal fluoride, a metal hydroxide, or a combination thereof. The inorganic filler may include, for example, at least one of alumina (e.g., Al₂O₃), SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include, but is not limited to, at least one of an acryl compound, an imide compound, an amide compound, or a combination thereof. The organic filler may have a core-shell structure, but is not limited thereto.

The filler may be one or more of boehmite and alumina.

The filler may be spherical, platy, cubic, or amorphous. For example, the filler may have a plate shape.

The filler may have an average particle diameter D50 of about 0.5 μm or less, for example, 0.4 μm or less, or in a range of about 0.2 μm to about 0.35 μm. In the above range, there may be an effect of improving thermal shrinkage.

The aqueous binder and filler in the aqueous coating layer may be included in a weight ratio in a range of about 1:10 to about 1:50, for example, a weight ratio in a range of about 1:20 to about 1:30. In the above range, there may be an effect of further reducing the thermal shrinkage of the separator.

The aqueous coating layer may further include an adhesive binder.

The adhesive binder may include one or more of an aqueous adhesive binder and an organic adhesive binder. For example, the adhesive binder may be or include an aqueous adhesive binder. The adhesive binder may include one or more of a polyvinylidene fluoride copolymer such as polymethyl methacrylate (PMMA), polyvinylidene fluoride (PVDF), and polyvinylidene fluoride-hexafluoropropylene (PVDF-HFP).

The coating layer may have a thickness in a range of about 0.5 μm to about 5.0 μm, for example, 0.5 μm to 3 μm. In the above range, the porous substrate can be used in the separator.

The coating layer may be prepared by a conventional method known to those skilled in the art.

### Rechargeable Battery

Another example embodiment includes a rechargeable battery including the separator for a rechargeable battery according to one example embodiment, a positive electrode, and a negative electrode.

The separator for a rechargeable battery refers to the content described above. The separator for a rechargeable battery may be located between the positive electrode and the negative electrode.

The rechargeable battery may be a rechargeable lithium battery.

### Positive Electrode

A positive electrode for a rechargeable lithium battery may include a current collector and a positive electrode active material layer on the current collector. The positive electrode active material layer may include a positive electrode active material and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and also attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. For example, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone or in combination of two or more.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

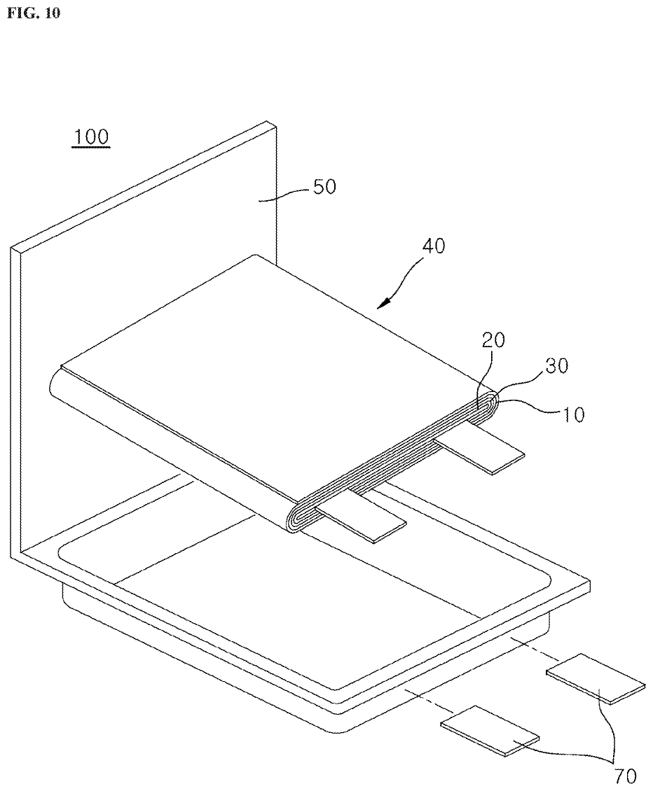

FIG. 7 to FIG. 10 are schematic views illustrating a rechargeable lithium battery according to an example embodiment. FIG. 7 shows a cylindrical battery, FIG. 8 shows a prismatic battery, and FIG. 9 and FIG. 10 show pouch-type batteries. Referring to FIG. 7 to FIG. 10, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 7. In FIG. 8, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 9 and FIG. 10, the rechargeable lithium battery 100 may include an electrode tab 70 illustrated in FIG. 10, or for example, a positive electrode tab 71 and a negative electrode tab 72 illustrated in FIG. 9, the electrode tabs 70/71/72 forming an electric path for inducing the current formed in the electrode assembly 40 to the outside of the rechargeable lithium battery 100.

The rechargeable lithium battery according to an example embodiment may be applicable to, e.g., automobiles, mobile phones, and/or various types of electric devices, as non-limiting examples.

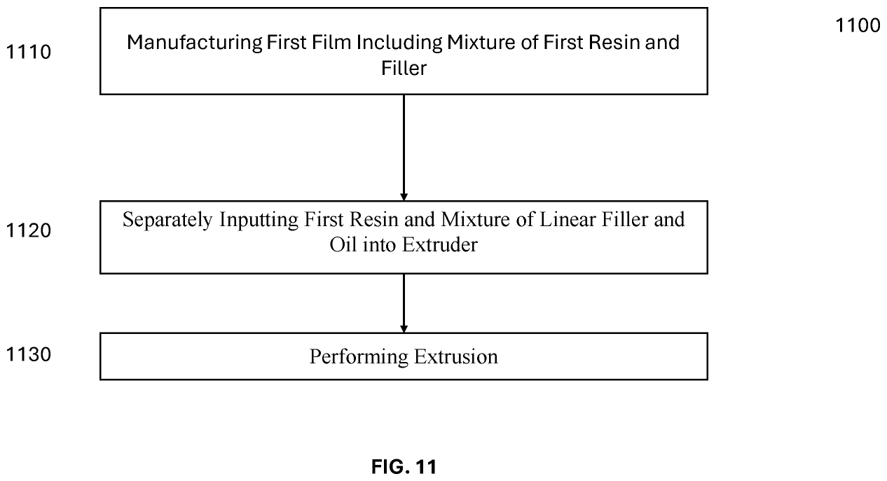

FIG. 11 is a flowchart illustrating a method of manufacturing a porous substrate of a separator for a rechargeable battery, according to an example embodiment. In FIG. 11, the method 1100 includes operation 1110, which includes manufacturing a first film including a mixture of a first resin and a filler. For example, the filler includes a linear filler. In another example, the manufacturing of the first film includes inputting the first resin into the extruder, and inputting the mixture of the linear filler and the oil into the extruder. For example, the oil includes paraffin oil. In yet another example, the linear filler includes nanofibers. In a further example, the linear filler has an aspect ratio of about 10 or more. In a further example, the first resin forming the filler has a weight average molecular weight of about 1.5 million g/mol or less. As an example, the first resin is a polyolefin-based resin. For example, the polyolefin-based resin has a weight average molecular weight of about 1.5 million g/mol or less. In another example, in the mixture of the first resin and the filler, the first resin is included in an amount in a range of about 50 wt % to about 80 wt %, and the filler is included in an amount in a range of about 20 wt % to about 50 wt %. In an additional example, the mixture of the linear filler and the oil is a dispersion containing a range of about 10 parts by weight to about 50 parts by weight of the linear filler based on 100 parts by weight of the oil. In a further example, the mixture of the linear filler and the oil is input multiple times in a divided manner.

In operation 1120, the manufacturing of the first film includes separately inputting the first resin and a mixture of the linear filler and oil into an extruder. For example, the linear filler includes a filler including the first resin. In another example, the manufacturing of the first film includes inputting the first resin into the extruder, melting the first resin, and inputting the mixture of the linear filler and the oil into the extruder. Operation 1130 includes performing extrusion. For example, the method includes inputting a mixture of the first resin and a film-forming solvent into a hopper connected to the extruder, melting the mixture, inputting the mixture of the linear filler and the oil into the extruder, and performing extrusion to manufacture the first film, stretching the first film to manufacture a second film, and removing the film-forming solvent and the oil from the second film to form a pore, thereby manufacturing the porous substrate. Hereinafter, examples and comparative examples of the present disclosure are described. However, the following examples are only examples of the present disclosure, and the present disclosure is not limited to the following examples.

### Example 1

A polyethylene film was manufactured using an extruder.

9 parts by weight of nanofibers formed of a polyethylene (PE)-based resin (weight average molecular weight of PE-based resin: 1.2 million g/mol) and 70 parts by weight of liquid paraffin were mixed and stirred to prepare a pre-dispersion of the PE-based resin nanofibers

30 parts by weight of a polyethylene-based resin (weight average molecular weight: 1.2 million g/mol) and 100 parts by weight of a film-forming solvent were input into a hopper connected to the extruder and the molten polyethylene-based resin was mixed and moved within the extruder through a screw while melting. During the movement of the above melt, the pre-dispersion was input, stirred and moved through the screw, then fed into a die in the extruder and extruded, and then the extruded molded body was cooled while being taken out by a cooling roll to manufacture a first film.

The first film was stretched uniaxially in the MD of the first film at a stretching ratio of 5 times using a stretching machine at a temperature in a range of 110 °C to 120 °C by wet stretching to manufacture a second film.

Liquid paraffin was extracted and removed from the second film using methylene chloride, and the resulting second film was dried at room temperature to manufacture a microporous membrane.

The microporous membrane was heat-set at a temperature in a range of 125 °C to 130 °C by a tenter method while shrinking 8% in the TD to manufacture a polyethylene-based porous substrate (thickness: 8 μm).

A composition for a coating layer was applied on the first surface of the porous substrate manufactured above and dried to form a coating layer (thickness: 2 μm), thereby manufacturing a separator. The composition for a coating layer includes boehmite (average particle diameter D50: 200 nm) and a binder. A binder:boehmite weight ratio is 1:20.

### Example 2

A porous substrate and a separator were manufactured in the same manner as in Example 1, except that in Example 1, 12 parts by weight of nanofibers formed of a PE-based resin (weight average molecular weight of the PE-based resin: 1.2 million g/mol), 70 parts by weight of liquid paraffin, and 30 parts by weight of a polyethylene-based resin (weight average molecular weight: 1.2 million g/mol) were used.

### Example 3

A porous substrate and a separator were manufactured in the same manner as in Example 1, except that in Example 1, 15 parts by weight of nanofibers formed of a PE-based resin (weight average molecular weight of the PE-based resin: 1.2 million g/mol), 70 parts by weight of liquid paraffin, and 30 parts by weight of a polyethylene-based resin (weight average molecular weight: 1.2 million g/mol) were used.

### Comparative Example 1

A porous substrate and a separator were manufactured in the same manner as in Example 1, except that in Example 1, the pre-dispersion of 30 parts by weight of nanofibers formed of the PE-based resin and 70 parts by weight of liquid paraffin was not input.

### Comparative Example 2

A polyethylene film was manufactured using an extruder.

30 parts by weight of a polyethylene-based resin (weight average molecular weight: 1.2 million g/mol), 100 parts by weight of a film-forming solvent, 30 parts by weight of nanofibers formed of a PE-based resin (weight average molecular weight of the PE-based resin: 1.2 million g/mol), and 70 parts by weight of liquid paraffin were input into a hopper connected to the extruder, and stirred and moved by a screw while melting. After the stirring and movement by the screw, the resulting mixture was fed into a die in the extruder and extruded, and then the extruded molded body was cooled while being taken out by a cooling roll to manufacture a first film.

The first film was stretched uniaxially in the MD of the first film at a stretching ratio of 5 times using a stretching machine at a temperature in a range of 110 °C to 120 °C by wet stretching to manufacture a second film.

Liquid paraffin was extracted and removed from the second film using methylene chloride, and the resulting second film was dried at room temperature to manufacture a microporous membrane.

The microporous membrane was heat-set at a temperature in a range of 125 °C to 130 °C by a tenter method while shrinking 8% in TD to manufacture a polyethylene-based porous substrate and a separator.

### Comparative Example 3

A porous substrate and a separator were manufactured in the same manner as in Example 1, except that in Example 1, cellulose-based nanofibers were used instead of nanofibers formed of the PE-based resin.

The physical properties of the prepared porous substrate as shown in Table 1 below were evaluated, and the evaluation results are shown in Table 1 below.

### (1) Puncture Strength (Units: Gf)

Ten specimens were fabricated by cutting the porous substrates manufactured in the examples and comparative examples at ten different points with a width (MD) of 50 mm×a length (TD) of 50 mm, the specimens were placed over a 10 cm hole using GATO Tech G5 equipment, and the puncture force was measured while pressing with a 1 mm probe. The puncture strength of each specimen was evaluated three times and the average value of the puncture strength was calculated.

(2) Air Permeability (Units: sec/100 cc)

For the porous substrates manufactured in the examples and comparative examples, the air permeability was measured by measuring the time (units: seconds) taken for 100 cc of air to pass through the separator using a measuring device (EG01-55-1MR, Asahi Seiko). The air permeability was measured twice and the average value was calculated.

Air permeability measurement device setting conditions:

Measurement pressure: 0.5 kg/cm³, cylinder pressure: 2.5 kg/cm², and setting time: 10 seconds.

### (3) Thermal Shrinkage Rate (Units: %)

The porous substrates of the examples and comparative examples were cut into a size of 8 cm×8 cm to prepare a specimen. After drawing a 5 cm×5 cm square on the surface of the specimen, the specimen was placed between paper or alumina powder, left in an oven at 120 °C for 1 hour, taken out, the dimensions of the sides of the drawn square were measured, and the shrinkage rate in each of the MD and TD was calculated. The shrinkage rate was calculated according to Mathematical Formula 1 below.

Shrinkage rate=(L0−L1)/L0×100. Mathematical Formula 1:

L0 is the initial length of the porous substrate, and L1 is the length of the porous substrate after leaving the porous substrate at 120 °C for 1 hour.

### (4) MD Tensile Strength (Units: Kgf/cm²)

The porous substrates of the examples and comparative examples were cut into 10 cm×1 cm pieces in the MD×TD to prepare specimens, the tensile strength was measured by stretching in the MD using a tensile strength measuring device (3343, Instron), and the average value for six porous substrate specimens was set as the tensile strength.

### (5) TD Tensile Strength (Units: Kgf/Cm²)

The porous substrates of the examples and comparative examples were cut into 10 cm×1 cm pieces in the TD×MD to prepare specimens, the tensile strength was measured by stretching in the TD using a tensile strength measuring device (3343, Instron), and the average value for six porous substrate specimens was set as the tensile strength.

### (6) MD Elongation (Units: %)

The porous substrates of the examples and comparative examples were cut into 10 cm×1 cm pieces in the MD×TD to prepare specimens, the length of the specimen stretched until it broke by pulling at 100 mm/min in the MD at room temperature using an Instron (3343, Instron) device was measured, and the ratio of the increase relative to the initial specimen length was calculated, and the average value for six porous substrate specimens was set as the elongation.

### (7) TD Elongation (Units: %)

The porous substrates of the examples and comparative examples were cut into 10 cm×1 cm pieces in the TD×MD to prepare specimens, the length of the specimen stretched until it broke by pulling at 100 mm/min in the TD at room temperature using an Instron (3343, Instron) device was measured, and the ratio of the increase relative to the initial specimen length was calculated, and the average value for six porous substrate specimens was set as the elongation.

(8) Physical Property Distribution: The Physical Properties of the Porous Substrate were Measured and the Relative Standard Deviation of the Properties was Calculated. The Above Physical Properties were Evaluated for Each of the Measured Puncture Strength, Air Permeability, Thermal Shrinkage Rate, Tensile Strength, and Elongation.

Relative standard deviation d=(physical property standard deviation/physical property mean)
∘: Relative standard deviation d<5%
Δ: Relative standard deviation 5%<d<20%
x: Relative standard deviation d>20%

TABLE 1

| | PE-based | | | Puncture | Air |
|---|---|---|---|---|---|
| | resin | Filler | Oil | strength | permeability |
| Example 1 | 30 | 9 | 70 | 627 | 131 |
| Example 2 | 30 | 12 | 70 | 652 | 134 |
| Example 3 | 30 | 15 | 70 | 670 | 132 |
| Comparative | 30 | — | 70 | 510 | 125 |
| Example 1 | | | | | |
| Comparative | 30 | 30 | 70 | 550 | 135 |
| Example 2 | | | | | |
| Comparative | 30 | 9 | 70 | 380 | 152 |
| Example 3 | | | | | |

TABLE 1

| | | | | | | | Physical |
|---|---|---|---|---|---|---|---|
| | Thermal | | Tensile | | | | property |
| | shrinkage rate | | strength | | Elongation | | distri- |
| | MD | TD | MD | TD | MD | TD | bution |
| Example 1 | 8.1 | 8.2 | 2652 | 2591 | 101 | 88 | ∘ |
| Example 2 | 5.6 | 6.1 | 2976 | 2725 | 97 | 87 | ∘ |
| Example 3 | 3.2 | 2.8 | 3171 | 3208 | 91 | 83 | ∘ |
| Comparative | 12.3 | 13.4 | 2842 | 2852 | 103 | 90 | ∘ |
| Example 1 | | | | | | | |
| Comparative | 6.7 | 7.0 | 2073 | 2152 | 87 | 75 | Δ |
| Example 2 | | | | | | | |
| Comparative | 10.1 | 11.3 | 1811 | 1738 | 57 | 42 | x |
| Example 3 | | | | | | | |

As shown in Table 1 above, the methods of the examples can improve the reliability and safety of the battery by providing porous substrates with improved puncture strength, air permeability, thermal shrinkage, and tensile strength.

In particular, although not described in Table 1 above, the porous substrate of Comparative Example 3 was torn at the interface between the matrix and the pores during the stretching process.

### Example 4

A monomer mixture including 5 wt % of ethyl acrylate and 95 wt % of ethylene was polymerized to prepare a copolymer.

The prepared copolymer and a polyolefin-based resin were mixed in a ratio of 20 parts by weight to 80 parts by weight based on a total of 100 parts by weight to prepare a mixture, and liquid paraffin and the like were added to prepare a composition for manufacturing an intermediate layer.

Liquid paraffin and the like were added to the copolymer to prepare a composition for a first surface layer and a composition for a second surface layer.

The composition for manufacturing an intermediate layer, the composition for a first surface layer, and the composition for a second surface layer were introduced, melted, fed into a co-extruder, then fed into a die, extruded, and then cooled while taking the extruded molded body out with a cooling roll. A laminate obtained by cooling was stretched uniaxially in the MD at a stretching ratio of 5 times using a stretching machine at a temperature in a range of 110 °C to 120 °C by wet stretching, and liquid paraffin was extracted and removed using methylene chloride, and the resulting laminate was dried at room temperature to manufacture a porous substrate (thickness: 14 μm).

The porous substrate includes a mixture of the copolymer and the polyolefin-based resin in a ratio in a range of 20 parts by weight to 80 parts by weight based on a total of 100 parts by weight, and has a porous intermediate layer (thickness: 2 μm), and a porous first surface layer (thickness: 5 μm) and the second surface layer (thickness: 5 μm) each made of the copolymer.

A composition for an aqueous coating layer was applied on each side of the manufactured porous substrate, and dried to form a coating layer (thickness: 2 μm), thereby manufacturing a separator. The composition for a coating layer includes boehmite (average particle diameter D50: 200 nm), a binder, and water. The weight ratio of binder and boehmite is 1:20, and the binder is an aqueous binder having a repeating unit derived from 2-(meth)acrylamido-2-methylpropane sulfonic acid and a repeating unit derived from (meth)acrylic acid.

### Example 5

A separator was manufactured in the same manner as in Example 4, except that the monomer mixture for a copolymer was changed to 2 wt % of ethyl acrylate and 98 wt % of ethylene.

### Example 6

A separator was manufactured in the same manner as in Example 4, except that the monomer mixture for a copolymer was changed to 20 wt % of ethyl acrylate and 80 wt % of ethylene.

### Example 7

A separator was manufactured in the same manner as in Example 4, except that the monomer mixture for a copolymer was changed to 15 wt % of ethyl acrylate and 85 wt % of ethylene.

### Comparative Example 4

A separator was manufactured in the same manner as in Example 4, except that a stretched film (thickness: 14 μm) made of the polyolefin-based resin was used as a porous substrate. The stretched film was manufactured in substantially the same manner as in Example 4 using the polyolefin-based resin.

### Comparative Example 5

A separator was manufactured in the same manner as in Example 4, except that a stretched film (thickness: 14 μm) made of the copolymer was used as the porous substrate in Example 4. The stretched film was manufactured in substantially the same manner as in Example 4 using the copolymer.

### Comparative Example 6

A separator was manufactured in the same manner as in Example 4, except that the monomer mixture for a copolymer was changed to 0.2 wt % of ethyl acrylate and 99.8 wt % of ethylene.

### Comparative Example 7

A separator was manufactured in the same manner as in Example 4, except that the monomer mixture for a copolymer was changed to 70 wt % of ethyl acrylate and 30 wt % of ethylene.

### Comparative Example 8

A separator was manufactured in the same manner as in Example 4, except that a stretched film (thickness: 14 μm) including the mixture of the copolymer and the polyolefin-based resin was used as a porous substrate. The stretched film was manufactured in substantially the same manner as in Example 4 using the mixture of the copolymer and the polyolefin-based resin.

The physical properties of the prepared porous substrate as shown in Table 2 below were evaluated, and the evaluation results are shown in Table 2 below.

### (1) Puncture Strength (Units: gf)

Ten specimens were fabricated by cutting the porous substrates manufactured in the examples and comparative examples at ten different points with a width (MD) of 50 mm×length (TD) of 50 mm, the specimens were placed over a 10 cm hole using GATO Tech G5 equipment, and the puncture force was measured while pressing with a 1 mm probe. The puncture strength of each specimen was evaluated three times and the average value of the puncture strength was calculated.

### (2) Thermal Shrinkage Rate (Units: %)

The porous substrates of the examples and comparative examples were cut into a size of 8 cm×8 cm to prepare a specimen. After drawing a 5 cm×5 cm square on the surface of the specimen, the specimen was placed between paper or alumina powder, left in an oven at 120 °C for 1 hour, taken out, the dimensions of the sides of the drawn square were measured, and the shrinkage rate in each of the MD and TD was calculated. The shrinkage rate was calculated according to Mathematical Formula 1 below.

### Mathematical Formula 1:

$$Shrinkage rate = ( L 0 - L 1 ) / L 0 \times 100.$$

L0 is the initial length of the porous substrate, and L1 is the length of the porous substrate after leaving the porous substrate at 120 °C for 1 hour.

(3) Weight Change after Electrolyte Impregnation (Units: g) (Electrolyte Impregnability)

The porous substrates of the examples and comparative examples were cut into a size of 8 cm×8 cm to prepare a sample, and the initial weight W1 of the sample was measured. The sample was completely immersed in an electrolyte (1.5M LiPF₆ dissolved in ethylene carbonate, ethyl methyl carbonate, and dimethyl carbonate (20:40:40 volume ratio), 25 °C) and left for 1 day. The sample was removed, and then the weight W2 was measured. The weight change was calculated from W2−W1=W.

### (4) Contact Angle (Units: °)

The water contact angle at 25 °C was measured for the porous substrates of the examples and comparative examples using a POENIX-MT (Surface Electro Optics Co., Ltd.) contact angle measuring device.

The contact angle was evaluated as ‘Excellent’ for 30° or less, ‘Good’ for 30° to 50°, ‘Average’ for 50° to 100°, and ‘Poor’ for greater than 100°.

### (5) Coating Layer Adhesion

The adhesion between the coating layer and the porous substrate was evaluated according to the ASTM D903-98 (re-approved 2004) standard. Using an Instron universal testing machine, the peel rate was set to 20 mm/min, the peel length to 40 mm, the specimen width to 12 mm, and the peel angle between the tape and the specimen to 180°. The adhesion was defined as the average load calculated from five peaks within a designated stable region that exhibits the least noise among the load values measured during peeling.

The adhesion was evaluated as ‘Good’ for 2 N or more, ‘Average’ for more than 1 N and less than 2 N, ‘Poor’ for 1 N or less, and ‘Excellent’ for 3 N or more.

### (6) Electrolyte Wettability

The measured electrolyte impregnability and water contact angle were comprehensively evaluated. The better the electrolyte impregnability and the lower the water contact angle, the better the evaluation among ‘Good,’ ‘Average,’ and ‘Poor.’

TABLE 2

| | Porous | | Thermal | | Electrolyte | | | |
|---|---|---|---|---|---|---|---|---|
| | substrate | Puncture | shrinkage | | impregnation | Contact | Coating | Electrolyte |
| | thickness | strength | MD | TD | W | angle | adhesion | wettability |
| Example 4 | 14 | 600 | 3.2 | 2.8 | 1.5 | 25° | Excellent | Excellent |
| Example 5 | 14 | 600 | 7.6 | 7.5 | 0.9 | 87° | Average | Average |
| Example 6 | 14 | 480 | 4.3 | 3.5 | 1.2 | 49° | Good | Good |
| Example 7 | 14 | 600 | 3.5 | 3.1 | 1.5 | 29° | Excellent | Excellent |
| Comparative | 14 | 530 | 12 | 13.1 | 0.2 | 104° | Poor | Poor |
| Example 4 | | | | | | | | |
| Comparative | 14 | 350 | 3.4 | 3.1 | 1.5 | 29° | Excellent | Excellent |
| Example 5 | | | | | | | | |
| Comparative | 14 | 510 | 12.1 | 13.4 | 0.3 | 102° | Poor | Poor |
| Example 6 | | | | | | | | |
| Comparative | 14 | 350 | 4.5 | 4.2 | 1.5 | 28° | Excellent | Excellent |
| Example 7 | | | | | | | | |
| Comparative | 14 | 530 | 5.4 | 5.8 | 1.2 | 49° | Average | Good |
| Example 8 | | | | | | | | |

As shown in Table 2 above, the porous substrate of the examples has good adhesion between the porous substrate and the aqueous coating layer, improved electrolyte wettability of the porous substrate, and improved puncture strength.

### Example 8

Nylon 12 and a polyethylene-based resin were mixed in a ratio of 15 parts by weight to 85 parts by weight based on a total of 100 parts by weight to prepare a mixture, and liquid paraffin was added the mixture to prepare a composition for manufacturing an intermediate layer.

Liquid paraffin was added to nylon 12 to prepare each of a composition for a first surface layer and a composition for a second surface layer.

The composition for manufacturing an intermediate layer, the composition for a first surface layer, and the composition for a second surface layer were introduced, melted, fed into a co-extruder, then fed into a die, extruded, and then cooled while taking the extruded molded body out with a cooling roll. A laminate obtained by cooling was stretched uniaxially in MD at a stretching ratio of 5 times using a stretching machine at a temperature in a range of 110 °C to 120 °C by wet stretching, and liquid paraffin was extracted and removed using methylene chloride, and the resulting methylene chloride was dried at room temperature to manufacture a porous substrate (thickness: 14 μm).

The porous substrate includes a mixture of the nylon 12 and the polyethylene-based resin in a ratio of 15 parts by weight to 85 parts by weight based on a total of 100 parts by weight, and has a porous intermediate layer (thickness: 2 μm), and a porous first surface layer (thickness: 5 μm) and the second surface layer (thickness: 5 μm), each made of the nylon 12.

A composition for an aqueous coating layer was applied on each side of the manufactured porous substrate, and dried to form a coating layer (thickness: 2 μm), thereby manufacturing a separator. The composition for the coating layer includes boehmite (average particle diameter D50: 200 nm), a binder, and water. The weight ratio of binder and boehmite is 1:20, and the binder is an aqueous binder having a repeating unit derived from 2-(meth)acrylamido-2-methylpropane sulfonic acid and a repeating unit derived from (meth)acrylic acid.

### Example 9

The nylon 12 and the polyethylene-based resin were mixed in a ratio of 15 parts by weight and 75 parts by weight and 10 parts by weight of an ethylene-vinyl alcohol copolymer as a surfactant based on a total of 100 parts by weight, was added to prepare a mixture, and liquid paraffin was added the mixture to prepare a composition for manufacturing an intermediate layer.

A separator was manufactured in the same manner as in Example 8, except that the composition for manufacturing an intermediate layer described above was used.

### Example 10

90 parts by weight of ethylene and 10 parts by weight of glycidyl methacrylate as a comonomer were polymerized to prepare a surfactant.

The nylon 12 and the polyethylene-based resin were mixed in a ratio of 15 parts by weight and 75 parts by weight, and then 10 parts by weight of the prepared surfactant, based on a total of 100 parts by weight was added thereto to prepare a mixture, and liquid paraffin was added the mixture to prepare a composition for manufacturing an intermediate layer.

A separator was manufactured in the same manner as in Example 8, except that the composition for manufacturing an intermediate layer described above was used.

### Example 11

90 parts by weight of ethylene and 10 parts by weight of maleic anhydride as a comonomer were polymerized to prepare a surfactant.

The nylon 12 and the polyethylene-based resin were mixed in a ratio of 15 parts by weight and 75 parts by weight, 10 parts by weight of the prepared surfactant based on a total of 100 parts by weight was added thereto, and then liquid paraffin and the like were added thereto to prepare a mixture, and liquid paraffin was added the mixture to prepare a composition for manufacturing an intermediate layer.

A separator was manufactured in the same manner as in Example 8, except that the composition for manufacturing an intermediate layer described above was used.

### Comparative Example 9

A separator was manufactured in the same manner as in Example 8, except that a polyethylene resin was used for each of the first surface layer and the second surface layer.

### Comparative Example 10

In Example 8, polyvinyl acetate and polyethylene-based resin were mixed in a ratio of 20 parts by weight to 80 parts by weight to prepare a mixture, and liquid paraffin and the like were added the mixture to prepare a composition for manufacturing an intermediate layer.

A separator was manufactured in the same manner as in Example 8, except that the composition for manufacturing an intermediate layer described above was used.

The physical properties of the prepared porous substrate and separator as shown in Table 3 below were evaluated, and the evaluation results are shown in Table 3 below.

### (1) Puncture Strength (Units: gf)

Ten specimens were fabricated by cutting the porous substrates manufactured in the examples and comparative examples at ten different points with a width (MD) of 50 mm×length (TD) of 50 mm, the specimens were placed over a 10 cm hole using GATO Tech G5 equipment, and the puncture force was measured while pressing with a 1 mm probe. The puncture strength of each specimen was evaluated three times and the average value of the puncture strength was calculated.

### (2) Thermal Shrinkage Rate (Units: %)

The porous substrates of the examples and comparative examples were cut into a size of 8 cm×8 cm to prepare a specimen. After drawing a 5 cm×5 cm square on the surface of the specimen, the specimen was placed between paper or alumina powder, left in an oven at 120 °C for 1 hour, taken out, the dimensions of the sides of the drawn square were measured, and the shrinkage rate in each of the MD and TD was calculated. The shrinkage rate was calculated according to Mathematical Formula 1 below.

### Mathematical Formula 1:

$$Shrinkage rate = ( L 0 - L 1 ) / L 0 \times 100.$$

L0 is the initial length of the porous substrate, and L1 is the length of the porous substrate after leaving the porous substrate at 120 °C for 1 hour.

(3) Weight Change after Electrolyte Impregnation (Units: g)

The porous substrates of the examples and comparative examples were cut into a size of 8 cm×8 cm to prepare a sample, and the initial weight W1 of the sample was measured. The sample was completely immersed in an electrolyte (1.15M LiPF₆ dissolved in ethylene carbonate (EC), dimethyl carbonate (DMC) and ethyl methyl carbonate (EMC) (20:40:40 volume ratio), 25 °C) and left for 1 day. The sample was removed, and then the weight W2 was measured. The weight change was calculated from W2−W1=ΔW. The weight change was evaluated as ‘Excellent’ for 1.5 g or more, ‘Good’ for 1.0 g to less than 1.5 g, ‘Average’ for 0.4 g to less than 1.0 g, and ‘Poor’ for less than 0.4 g.

(4) Contact Angle (units: °)

The water contact angle at 25 °C was measured for the porous substrates of the examples and comparative examples using a POENIX-MT (Surface Electro Optics Co., Ltd.) contact angle measuring device. The contact angle was evaluated as ‘Excellent’ for 30° or less, ‘Good’ for more than 30° and 50° or less, ‘Average’ for more than 50° and 100° or less, and ‘Poor’ for greater than 100°.

### (5) Coating Layer Adhesion

The adhesion between the coating layer and the porous substrate was evaluated according to the ASTM D903-98 (re-approved 2004) standard. Using an Instron universal testing machine, the peel rate was set to 20 mm/min, the peel length to 40 mm, the specimen width to 12 mm, and the peel angle between the tape and the specimen to 180°. The adhesion is defined as the average load calculated from five peaks within a designated stable region that exhibits the least noise among the load values measured during peeling. The adhesion was evaluated as ‘Good’ for 2 N or more and less than 3 N, ‘Average’ for 1 N or more and less than 2 N, ‘Poor’ for less than 1 N, and ‘Excellent’ for 3 N or more.

### (6) Electrolyte Wettability

The above (3) and (4) were comprehensively evaluated. When both (3) and (4) were desired or improved, it was evaluated as ‘Excellent’; when one or more of (3) and (4) were good, it was evaluated as ‘Good’; when one or more of (3) and (4) were average, it was evaluated as ‘Average’; and when one or more of (3) and (4) were poor, it was evaluated as ‘Poor’.

TABLE 3

| | Porous | | Thermal | | Electrolyte | | | |
|---|---|---|---|---|---|---|---|---|
| | substrate | Puncture | shrinkage | | impregnation | Contact | Coating | Electrolyte |
| | thickness | strength | MD | TD | ΔW | angle | adhesion | wettability |
| Example 8 | 14 | 410 | 11.0 | 11.1 | 1.2 | 25° | Good | Good |
| Example 9 | 14 | 510 | 8.7 | 6.5 | 1.3 | 27° | Good | Good |
| Example 10 | 14 | 601 | 3.1 | 2.7 | 1.7 | 25° | Excellent | Excellent |
| Example 11 | 14 | 603 | 3.4 | 2.5 | 1.7 | 26° | Excellent | Excellent |
| Comparative | 14 | 560 | 13.8 | 14.5 | 0.2 | 104° | Poor | Poor |
| Example 9 | | | | | | | | |
| Comparative | 14 | 408 | 12.1 | 13.4 | 0.9 | 38° | Average | Good |
| Example 10 | | | | | | | | |

As shown in Table 3 above, the porous substrate of the examples had improved puncture strength, improved electrolyte impregnability and electrolyte wettability, and desired or improved adhesion to the aqueous coating layer.

However, the separator of the comparative examples did not have a good effect compared to the separator of the examples.

According to one example embodiment, a rechargeable battery is provided in which the adhesion between a porous substrate and an aqueous coating layer is desired or improved, and thermal shrinkage in each of the machine direction and the transverse direction of the porous substrate is remarkably low, thereby increasing the reliability and safety of the battery.

According to another example embodiment, electrolyte wettability or electrolyte impregnability is improved, thereby improving the output of the battery and enhancing the capacity of the battery.

Still according to another example embodiment, puncture strength is improved, thereby enhancing the strength and reliability of the separator.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A method of manufacturing a porous substrate of a separator for a rechargeable battery, the method comprising:
manufacturing a first film including a mixture of a first resin and a filler,
wherein the filler includes a linear filler,
the manufacturing of the first film includes separately inputting the first resin and a mixture of the linear filler and oil into an extruder and performing extrusion, and
the linear filler includes a filler including the first resin.

2. The method of claim 1, wherein the manufacturing of the first film comprises:
inputting the first resin into the extruder; and
inputting the mixture of the linear filler and the oil into the extruder.

3. The method of claim 2, wherein the linear filler comprises nanofibers.

4. The method of claim 3, wherein the linear filler has an aspect ratio of about 10 or more.

5. The method of claim 2, wherein the first resin forming the filler has a weight average molecular weight of about 1.5 million g/mol or less.

6. The method of claim 2, wherein the first resin is a polyolefin-based resin.

7. The method of claim 6, wherein the polyolefin-based resin has a weight average molecular weight of about 1.5 million g/mol or less.

8. The method of claim 2, wherein in the mixture of the first resin and the filler, the first resin is included in an amount in a range of about 50 wt % to about 80 wt %, and the filler is included in an amount in a range of about 20 wt % to about 50 wt %.

9. The method of claim 2, wherein the mixture of the linear filler and the oil is a dispersion containing a range of about 10 parts by weight to about 50 parts by weight of the linear filler based on 100 parts by weight of the oil.

10. The method of claim 2, wherein the mixture of the linear filler and the oil is input multiple times in a divided manner.

11. The method of claim 2, wherein the manufacturing of the first film comprises:
inputting the first resin into the extruder;
melting the first resin; and
inputting the mixture of the linear filler and the oil into the extruder.

12. The method of claim 2, wherein the oil comprises paraffin oil.

13. The method of claim 2, comprising:
inputting a mixture of the first resin and a film-forming solvent into a hopper connected to the extruder, melting the mixture, inputting the mixture of the linear filler and the oil into the extruder, and performing extrusion to manufacture the first film;
stretching the first film to manufacture a second film; and
removing the film-forming solvent and the oil from the second film to form a pore, thereby manufacturing the porous substrate.

14. A porous substrate for a separator of a rechargeable battery, the porous substrate comprising:
a porous matrix including a first resin; and
a filler impregnated into the matrix,
wherein the filler includes a linear filler, and the linear filler includes a filler including the first resin, and
a puncture strength is about 600 gf or more, an air permeability is about 200 sec/100 cc or less, and a thermal shrinkage rate is about 5% or less in each of a machine direction and a transverse direction.

15. The porous substrate of claim 14, wherein:
the first resin in the matrix comprises a polyethylene-based resin; and
the linear filler comprises a polyethylene-based nanofiber.

16. The porous substrate of claim 15, wherein the nanofiber has a diameter of about 500 nm or less, and an aspect ratio of about 10 or more.

17. The porous substrate of claim 15, wherein the polyethylene-based resin in the matrix has a weight average molecular weight of about 1.5 million g/mol or less, and the polyethylene-based resin in the linear filler has a weight average molecular weight of about 1.5 million g/mol or less.

18. The porous substrate of claim 15, wherein in the porous substrate:
the matrix is included in an amount in a range of about 50 wt % to about 80 wt %; and
the filler is included in an amount in a range of about 20 wt % to about 50 wt %.

19. A separator for a rechargeable battery, the separator comprising the porous substrate of claim 14.

20. A rechargeable battery comprising a positive electrode, a negative electrode, and the separator for a rechargeable battery of claim 19 located between the positive electrode and the negative electrode.
